(19) United States
(12) Patent Application Publication
(10) Pub. No.: US 2024/0113847 A1
(43) Pub. Date: Apr. 4, 2024

(54) CONTROL CHANNEL RECEPTION IN FULL DUPLEX TIME INTERVALS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/461,278

(22) Filed: Sep. 5, 2023

Related U.S. Application Data
(60) Provisional application No. 63/412,320, filed on Sep. 30, 2022.

(51) Int. Cl. H04L 5/14; H04L 5/00; H04W 72/0453; H04W 72/1273

(52) U.S. Cl. CPC H04L 5/14; H04L 5/0048; H04W 72/0453; H04W 72/1273

(57) ABSTRACT

Methods, systems, and devices for wireless communications are described. A user equipment (UE) may support partial monitoring of control resource sets (CORESETs) that overlap with uplink subbands in a full duplex time interval under certain conditions. The UE may monitor physical downlink control channel (PDCCH) candidates in the downlink subband and ignore PDCCH candidates in the uplink subband. In some examples, a UE may support monitoring of CORESETs that overlap with the uplink subbands. In such examples, the UE may assume that symbols containing CORESETs are downlink symbols (e.g., such that the symbols of the CORESET overlapping with the uplink subband are used as downlink symbols).

### CROSS REFERENCE

The present application for patent claims the benefit of U.S. Provisional Patent Application No. 63/412,320 by IBRAHIM et al., entitled “CONTROL CHANNEL RECEPTION IN FULL DUPLEX TIME INTERVALS,” filed Sep. 30, 2022, assigned to the assignee hereof, and expressly incorporated by reference herein.

### FIELD OF TECHNOLOGY

The following relates to wireless communications, including control channel reception in full duplex time intervals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support control channel reception in full duplex time intervals. Existing user equipments (UEs) may not support receiving downlink signaling overlapping with an uplink subband in a subband full duplex (SBFD) slot.

In some examples, instead of dropping all monitoring occasions of a control resource set (CORESET) that overlaps at least partially with an uplink subband of the SBFD slot, the UE may support partial monitoring under certain conditions. For example, the CORESET may be configured such that a number of physical downlink control channel (PDCCH) candidates of the CORESET satisfies a threshold (e.g., no more PDCCH candidates than resources available in the downlink subband). In some such cases, interleaving of PDCCH candidates in the CORESET may be turned off such that a single block of consecutive PDCCH candidates of the CORESET is configured, and the UE monitors any of the block of CCEs located in the downlink subband (e.g., and drops monitoring occasions in the uplink subband). In some examples, interleaving may be enabled, but the UE may ignore any interleaved PDCCH candidates located in the uplink subband, or the network may configure an interleaving pattern that interleaves the PDCCH candidates in the downlink subband (but not in the uplink subband).

A UE may be scheduled to monitor CORESETs that overlap with the uplink subband. In such examples, the UE may assume that symbols containing CORESETs are downlink symbols. This may apply (e.g., as defined in one or more standards documents, or as indicated by the network, or both) to CORESETs that partially overlap the uplink subband, or may also include CORESETs that entirely overlap with (e.g., are located within) the uplink subband. In some examples, specific CORESET types (e.g., CORESET0, common CORESETs) may support downlink symbols in the uplink subband for the CORESET. In some examples, the configuration of the CORESET may indicate specific search spaces that support downlink symbols in the uplink subband.

A method for wireless communications at a user equipment (UE) is described. The method may include receiving control signaling indicating a CORESET during a full duplex slot, the CORESET including a set of multiple control channel candidates associated with a downlink control channel, where the CORESET at least partially overlaps in frequency with an uplink subband of a SBFD slot and selecting, for monitoring by the UE during the SBFD slot, a quantity of control channel candidates from the set of multiple control channel candidates of the CORESET that at least partially overlaps in frequency with the uplink subband.

An apparatus for wireless communications at a UE is described. The apparatus may include a processor, memory coupled with the processor, and instructions stored in the memory. The instructions may be executable by the processor to cause the apparatus to receive control signaling indicating a CORESET during a full duplex slot, the CORESET including a set of multiple control channel candidates associated with a downlink control channel, where the CORESET at least partially overlaps in frequency with an uplink subband of a SBFD slot and select, for monitoring by the UE during the SBFD slot, a quantity of control channel candidates from the set of multiple control channel candidates of the CORESET that at least partially overlaps in frequency with the uplink subband.

Another apparatus for wireless communications at a UE is described. The apparatus may include means for receiving control signaling indicating a CORESET during a full duplex slot, the CORESET including a set of multiple control channel candidates associated with a downlink control channel, where the CORESET at least partially overlaps in frequency with an uplink subband of a SBFD slot and means for selecting, for monitoring by the UE during the SBFD slot, a quantity of control channel candidates from the set of multiple control channel candidates of the CORESET that at least partially overlaps in frequency with the uplink subband.

A non-transitory computer-readable medium storing code for wireless communications at a UE is described. The code may include instructions executable by a processor to receive control signaling indicating a CORESET during a full duplex slot, the CORESET including a set of multiple control channel candidates associated with a downlink control channel, where the CORESET at least partially overlaps in frequency with an uplink subband of a SBFD slot and select, for monitoring by the UE during the SBFD slot, a quantity of control channel candidates from the set of multiple control channel candidates of the CORESET that at least partially overlaps in frequency with the uplink subband.

Some examples of the method, apparatuses, and non-transitory computer-readable medium described herein may further include operations, features, means, or instructions for receiving one or more downlink control information messages via the selected quantity of control channel candidates based on monitoring one or more search spaces of the selected quantity of control channel candidates, where the selected quantity of control channel candidates may be located in a downlink subband of the SBFD slot, where the selecting includes excluding a second quantity of control channel candidates from the set of multiple control channel candidates that may be located in the uplink subband.

In some examples of the method, apparatuses, and non-transitory computer-readable medium described herein, the selected quantity of control channel candidates satisfies a threshold quantity of control channel candidates associated with a quantity of frequency resources corresponding to the downlink subband, and the selecting may be based on the quantity of control channel candidates satisfying the threshold quantity of control channel candidates.

Some examples of the method, apparatuses, and non-transitory computer-readable medium described herein may further include operations, features, means, or instructions for mapping the set of multiple control channel candidates to a set of multiple consecutive control channel elements (CCEs) based on the control signaling, where a first subset of the set of multiple consecutive CCEs corresponding to the selected quantity of control channel candidates may be located in the downlink subband and a second subset of the set of multiple consecutive CCEs may be located in the uplink subband, where the receiving may be based least in part on the mapping.

Some examples of the method, apparatuses, and non-transitory computer-readable medium described herein may further include operations, features, means, or instructions for mapping the set of multiple control channel candidates to a set of multiple interleaved CCEs based on the control signaling, where a first subset of the set of multiple interleaved CCEs corresponding to the selected quantity of control channel candidates may be located in the downlink subband and a second subset of the set of multiple interleaved CCEs may be located in the uplink subband, where the receiving may be based on the mapping, and where the first subset of the set of multiple interleaved CCEs corresponds to the selected quantity of control channel candidates.

Some examples of the method, apparatuses, and non-transitory computer-readable medium described herein may further include operations, features, means, or instructions for receiving, via the control signaling, an indication of a first interleaving pattern associated with a first set of frequency resources associated with the CORESET and a second interleaving pattern associated with a subset of the first set of frequency resources that may be associated with a portion of the CORESET that overlaps with downlink subband and mapping the selected quantity of control channel candidates to a set of multiple interleaved CCEs in the SBFD slot based on the second interleaving pattern, where the set of multiple interleaved CCEs may be located in the downlink subband, and where receiving the one or more downlink control information messages may be based on the mapping.

Some examples of the method, apparatuses, and non-transitory computer-readable medium described herein may further include operations, features, means, or instructions for receiving one or more downlink control information messages via the selected quantity of control channel candidates based on monitoring one or more search spaces of the selected quantity of control channel candidates, where a first portion of the selected quantity of control channel candidates may be located in a downlink subband of the SBFD slot and a second portion of the selected quantity of control channel candidates may be located in the uplink subband.

Some examples of the method, apparatuses, and non-transitory computer-readable medium described herein may further include operations, features, means, or instructions for determining that frequency resources of the uplink subband may be allocated as downlink resources during one or more time intervals associated with the second portion of the selected quantity of control channel candidates, where receiving the one or more downlink control information messages may be based on the determining.

Some examples of the method, apparatuses, and non-transitory computer-readable medium described herein may further include operations, features, means, or instructions for receiving, via the control signaling, an indication of a type of the CORESET, where receiving the one or more downlink control information messages may be based on the type of the CORESET.

Some examples of the method, apparatuses, and non-transitory computer-readable medium described herein may further include operations, features, means, or instructions for receiving, via the control signaling, an indication of the one or more search spaces that may be associated with the one or more downlink control information messages, where receiving the one or more downlink control information messages may be based on the indication of the one or more search spaces.

A method for wireless communications at a network entity is described. The method may include transmitting control signaling indicating a CORESET during a full duplex slot, the CORESET including a set of multiple control channel candidates associated with a downlink control channel, where the CORESET at least partially overlaps in frequency with an uplink subband of a SBFD slot and selecting, for monitoring by a UE during the SBFD slot, a quantity of control channel candidates from the set of multiple control channel candidates of the CORESET that at least partially overlaps in frequency with the uplink subband.

An apparatus for wireless communications at a network entity is described. The apparatus may include a processor, memory coupled with the processor, and instructions stored in the memory. The instructions may be executable by the processor to cause the apparatus to transmit control signaling indicating a CORESET during a full duplex slot, the CORESET including a set of multiple control channel candidates associated with a downlink control channel, where the CORESET at least partially overlaps in frequency with an uplink subband of a SBFD slot and select, for monitoring by a UE during the SBFD slot, a quantity of control channel candidates from the set of multiple control channel candidates of the CORESET that at least partially overlaps in frequency with the uplink subband.

Another apparatus for wireless communications at a network entity is described. The apparatus may include means for transmitting control signaling indicating a CORESET during a full duplex slot, the CORESET including a set of multiple control channel candidates associated with a downlink control channel, where the CORESET at least partially overlaps in frequency with an uplink subband of a SBFD slot and means for selecting, for monitoring by a UE during the SBFD slot, a quantity of control channel candidates from the set of multiple control channel candidates of the CORESET that at least partially overlaps in frequency with the uplink subband.

A non-transitory computer-readable medium storing code for wireless communications at a network entity is described. The code may include instructions executable by a processor to transmit control signaling indicating a CORESET during a full duplex slot, the CORESET including a set of multiple control channel candidates associated with a downlink control channel, where the CORESET at least partially overlaps in frequency with an uplink subband of a SBFD slot and select, for monitoring by a UE during the SBFD slot, a quantity of control channel candidates from the set of multiple control channel candidates of the CORESET that at least partially overlaps in frequency with the uplink subband.

Some examples of the method, apparatuses, and non-transitory computer-readable medium described herein may further include operations, features, means, or instructions for transmitting one or more downlink control information messages via one or more search spaces of the selected quantity of control channel candidates, where the selected quantity of control channel candidates may be located in a downlink subband of the SBFD slot, where the selecting includes excluding a second quantity of control channel candidates from the set of multiple control channel candidates that may be located in the uplink subband.

Some examples of the method, apparatuses, and non-transitory computer-readable medium described herein may further include operations, features, means, or instructions for indicating, via the control signaling, a quantity of control channel candidates based on a threshold quantity of control channel candidates associated with a quantity of frequency resources corresponding to the downlink subband, where the selecting may be based on the quantity of control channel candidates satisfying the threshold quantity of control channel candidates.

Some examples of the method, apparatuses, and non-transitory computer-readable medium described herein may further include operations, features, means, or instructions for indicating, via the control signaling, a mapping of the set of multiple control channel candidates to a set of multiple consecutive CCEs, where a first subset of the set of multiple consecutive CCEs corresponding to the selected quantity of control channel candidates may be located in the downlink subband and a second subset of the set of multiple consecutive CCEs may be located in the uplink subband, where transmitting the one or more downlink control information messages may be based on the mapping.

Some examples of the method, apparatuses, and non-transitory computer-readable medium described herein may further include operations, features, means, or instructions for indicating, via the control signaling, a mapping of the set of multiple control channel candidates to a set of multiple interleaved CCEs, where a first subset of the set of multiple interleaved CCEs corresponding to the selected quantity of control channel candidates may be located in the downlink subband and a second subset of the set of multiple interleaved CCEs may be located in the uplink subband, where transmitting the one or more downlink control information messages may be based on the mapping.

Some examples of the method, apparatuses, and non-transitory computer-readable medium described herein may further include operations, features, means, or instructions for transmitting, via the control signaling, an indication of a first interleaving pattern associated with a first set of frequency resources associated with the CORESET and a second interleaving pattern associated with a subset of the first set of frequency resources that may be associated with a portion of the CORESET that overlaps with the downlink subband, where the selected quantity of control channel candidates may be mapped to a set of multiple interleaved CCEs in the downlink subband based on the second interleaving pattern.

Some examples of the method, apparatuses, and non-transitory computer-readable medium described herein may further include operations, features, means, or instructions for transmitting one or more downlink control information messages via one or more search spaces of the selected quantity of control channel candidates, where a first portion of the selected quantity of control channel candidates may be located in the downlink subband and a second portion of the selected quantity of control channel candidates may be located in the uplink subband.

Some examples of the method, apparatuses, and non-transitory computer-readable medium described herein may further include operations, features, means, or instructions for determining that frequency resources of the uplink subband may be allocated as downlink resources during one or more time intervals associated with the second portion of the selected quantity of control channel candidates, where transmitting the one or more downlink control information messages may be based on the determining.

Some examples of the method, apparatuses, and non-transitory computer-readable medium described herein may further include operations, features, means, or instructions for transmitting, via the control signaling, an indication of a type of the CORESET, where transmitting the one or more downlink control information messages may be based on the type of the CORESET.

Some examples of the method, apparatuses, and non-transitory computer-readable medium described herein may further include operations, features, means, or instructions for transmitting, via the control signaling, an indication of the one or more search spaces that may be associated with one or more downlink control information messages, where transmitting the one or more downlink control information messages may be based on the indication of the one or more search spaces.

### BRIEF DESCRIPTION OF THE DRAWINGS

FIG. 1 illustrates an example of a wireless communications system that supports control channel reception in full duplex time intervals in accordance with one or more aspects of the present disclosure.

FIG. 2 illustrates an example of a wireless communications system that supports control channel reception in full duplex time intervals in accordance with one or more aspects of the present disclosure.

FIG. 3 illustrates an example of a wireless communications system that supports control channel reception in full duplex time intervals in accordance with one or more aspects of the present disclosure.

FIG. 4 illustrates examples of wireless communications systems that support control channel reception in full duplex time intervals in accordance with one or more aspects of the present disclosure.

FIG. 5 illustrates an example of a duplexing configuration that supports control channel reception in full duplex time intervals in accordance with one or more aspects of the present disclosure.

FIG. 6 illustrates an example of a resource configuration that supports control channel reception in full duplex time intervals in accordance with one or more aspects of the present disclosure.

FIG. 7 illustrates an example of a resource configuration that supports control channel reception in full duplex time intervals in accordance with one or more aspects of the present disclosure.

FIG. 8 illustrates an example of a process flow that supports control channel reception in full duplex time intervals in accordance with one or more aspects of the present disclosure.

FIGS. 9 and 10 show block diagrams of devices that support control channel reception in full duplex time intervals in accordance with one or more aspects of the present disclosure.

FIG. 11 shows a block diagram of a communications manager that supports control channel reception in full duplex time intervals in accordance with one or more aspects of the present disclosure.

FIG. 12 shows a diagram of a system including a device that supports control channel reception in full duplex time intervals in accordance with one or more aspects of the present disclosure.

FIGS. 13 and 14 show block diagrams of devices that support control channel reception in full duplex time intervals in accordance with one or more aspects of the present disclosure.

FIG. 15 shows a block diagram of a communications manager that supports control channel reception in full duplex time intervals in accordance with one or more aspects of the present disclosure.

FIG. 16 shows a diagram of a system including a device that supports control channel reception in full duplex time intervals in accordance with one or more aspects of the present disclosure.

FIGS. 17 through 20 show flowcharts illustrating methods that support control channel reception in full duplex time intervals in accordance with one or more aspects of the present disclosure.

### DETAILED DESCRIPTION

A user equipment (UE) may support a subband full duplex (SBFD) mode of communication. The UE may be configured with uplink subbands and downlink subbands in one or more time intervals (e.g., an SBFD slot). The UE may also be configured with a control resource set (CORESET) on which to receive control signaling from the network. The CORESET may span the downlink subbands and one or more uplink subbands. Because the CORESET spans an uplink subband, without a mechanism for determining how to address downlink signaling on an uplink subband, the UE may ignore (e.g., not monitor) any CORESET that overlaps with an uplink subband. However, such techniques result in failure to receive control signaling, increased retransmissions, inefficient use of available system resources, increased system latency, decreased flexibility, and decreased user experience. Instead, as described herein, the UE may support partial or complete monitoring of CORESETs that overlap with an uplink subband.

A UE may not support receiving downlink signaling overlapping with an uplink subband. Instead of dropping all monitoring occasions of the CORESET, the UE may support partial monitoring under certain conditions. The CORESET may be configured such that a number of physical downlink control channel (PDCCH) candidates of the CORESET satisfies a threshold (e.g., no more PDCCH candidates than resources available in the downlink subband). Interleaving may be turned off in such cases, such that a single block of consecutive PDCCH candidates of the CORESET is configured, and the UE monitors any of the block of CCEs located in the downlink subband (e.g., and drops monitoring occasions in the uplink subband). In some examples, interleaving may be enabled, but the UE may ignore any interleaved PDCCH candidates located in the uplink subband, or the network may configure an interleaving pattern that interleaves the PDCCH candidates in the downlink subband (but not in the uplink subband).

A UE may be scheduled to monitor CORESETs that overlap with the uplink subband. In such examples, the UE may assume that symbols containing CORESETs are downlink symbols. This may apply (e.g., as defined in one or more standards documents, or as indicated by the network, or both) to CORESETs that partially overlap the uplink subband, or may also include CORESETs that entirely overlap with (e.g., are located within) the uplink subband. In some examples, specific CORESET types (e.g., CORESET0, common CORESETs) may support downlink symbols in the uplink subband for the CORESET. In some examples, the configuration of the CORESET may indicate specific search spaces that support downlink symbols in the uplink subband.

Aspects of the disclosure are initially described in the context of wireless communications systems. Aspects of the disclosure are further illustrated by and described with reference to wireless communications systems, duplexing configurations, and resource configurations. Aspects of the disclosure are further illustrated by and described with reference to apparatus diagrams, system diagrams, and flowcharts that relate to control channel reception in full duplex time intervals.

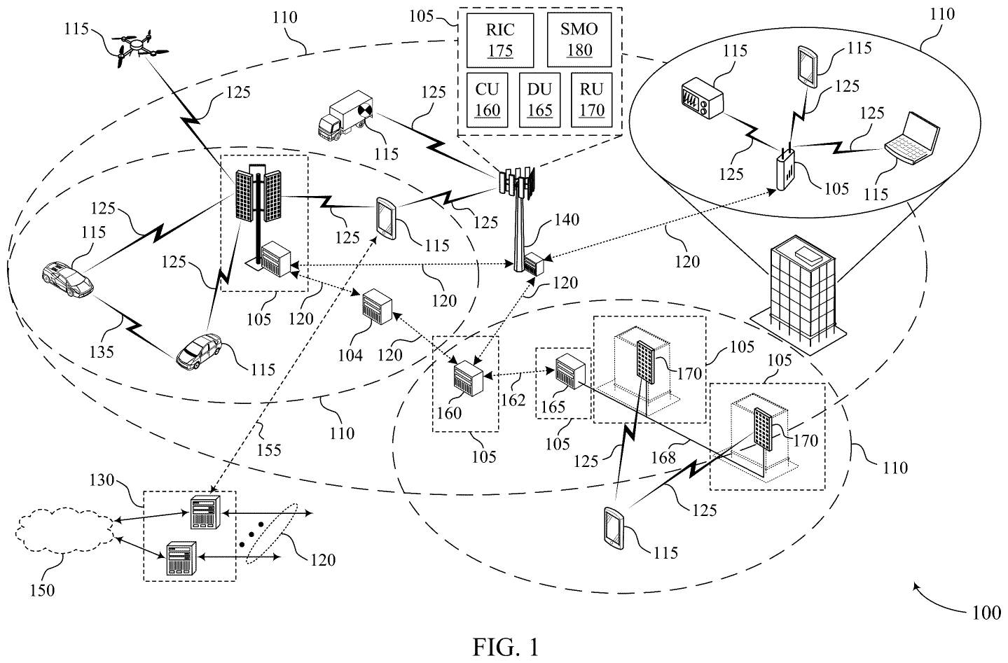

FIG. 1 illustrates an example of a wireless communications system 100 that supports control channel reception in full duplex time intervals in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support control channel reception in full duplex time intervals as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RB s)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support partial or complete monitoring of CORESETs that overlap with an uplink subband of an SBFD slot.

In some examples, instead of dropping all monitoring occasions of a CORESET that overlaps at least partially with an uplink subband of the SBFD slot, the UE 115 may support partial monitoring under certain conditions. The CORESET may be configured such that a number of physical downlink control channel (PDCCH) candidates of the CORESET satisfies a threshold, interleaving may be turned off in such cases and the UE 115 may monitor any PDCCH candidates located in the downlink subband (e.g., and drops monitoring occasions in the uplink subband), or interleaving may be enabled, but the UE 115 may ignore any interleaved PDCCH candidates located in the uplink subband, or the network may configure an interleaving pattern that interleaves the PDCCH candidates in the downlink subband (but not in the uplink subband).

A UE 115 may be scheduled to monitor CORESETs that overlap with the uplink subband. In such examples, the UE 115 may assume that symbols containing CORESETs are downlink symbols. This may apply (e.g., as defined in one or more standards documents, or as indicated by the network, or both) to CORESETs that partially overlap the uplink subband, or may also include CORESETs that entirely overlap with (e.g., are located within) the uplink subband. In some examples, specific CORESET types (e.g., CORESET0, common CORESETs) may support downlink symbols in the uplink subband for the CORESET. In some examples, the configuration of the CORESET may indicate specific search spaces that support downlink symbols in the uplink subband.

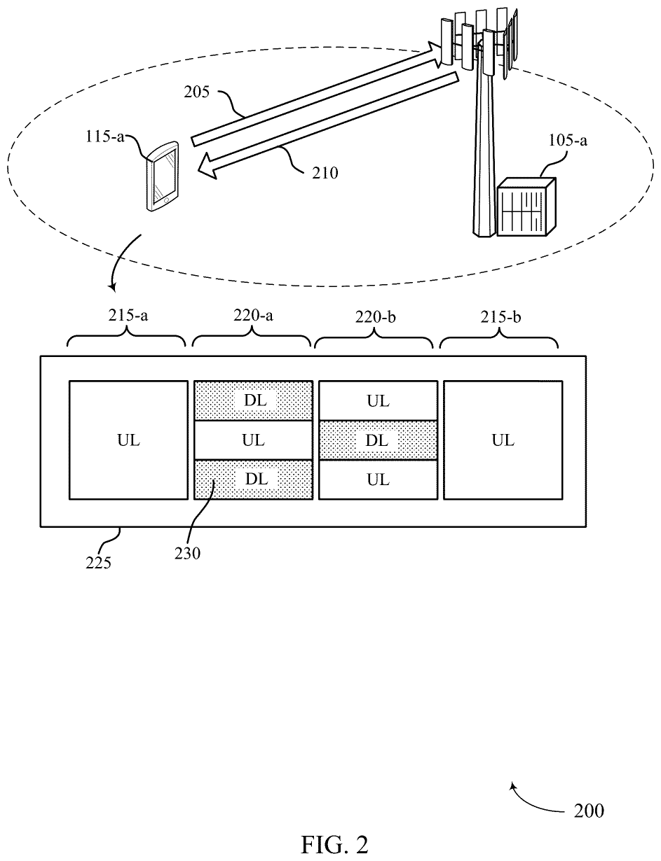

FIG. 2 illustrates an example of a wireless communications system 200 that supports control channel reception in full duplex time intervals in accordance with one or more aspects of the present disclosure. For example, wireless communications system 200 may support both half-duplex and full-duplex communications between devices such as a UE 115-a and a network entity 105-a.

While operating in a half-duplex mode, a wireless device such as a UE 115-a or network entity 105-a may transmit or receive uplink information (e.g., via uplink 205) during one time interval, and may transmit or receive downlink information (e.g., via downlink 210) during a different time interval. In some other examples, while operating in a full-duplex mode, the UE 115-a may transit uplink communications and receive downlink communications concurrently (e.g., at a same time and using a same time resource and different frequency resources). One example of such full-duplex operations may be in-band full-duplex (IBFD), which may allow transmitting and receiving terminals of the wireless device to transmit and receive simultaneously (e.g., at the same time and using the same time resource), and in the same frequency band. In such IBFD implementations, downlink and uplink communications may share the same IBFD time and frequency resource (e.g., the downlink and uplink resources may fully or partially overlap in time and frequency). Using IBFD, in some examples, may effectively increase (e.g., double) the spectrum utilization and throughout of the wireless system. A second example of full-duplex operations may be sub-band duplex communications (e.g., flexible duplex) where the wireless device may transmit and receive communications at the same time resource but on different frequency resources. In such examples, the downlink resource is separated from the uplink resource in the frequency domain via a guard band.

Some wireless networks may frequently switch between half-duplex configured slots (e.g., slot 215-a and slot 215-b) and full-duplex configured slots (e.g., slot 220-a and slot 220-b) of the resource allocation 225. For example, some full-duplex slots (e.g., slot 220-a and slot 220-b) may include multiple uplink and downlink sub-bands which may at least partially overlap with an allocated BWP 230 that is larger than the sub-band size. Various attributes of the BWP 230 are used in frequency domain resource assignment (FDRA) for communications using the full-duplex slot. For example, a first allocation type (e.g., allocation type 0) may be implemented for disjoint resource block allocation, where the network uses a bitmap (e.g., having 9 or 18 bits) to allocate a quantity of resource block groups (RBGs) for uplink or downlink communications within the full-duplex slot. In accordance with the resource allocation type 0, the RBG size allocated for communications is based on BWP size and the configuration type (e.g., RBG-Size; ENUMERATED {config1, config2}. For example, the RBG size P may be selected from a table such as table 1, shown below:

TABLE 1
Nominal RBG Size P

| BWP Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In some other examples, a second resource allocation type (e.g., allocation type 1) may be implemented to allocate a quantity of consecutive resource blocks for communications. Such resource allocations may be indicated by a first available resource block present in the BWP (e.g., RB_start) and the quantity of consecutive resource blocks that are combined in the resource indicator value (RIV) field. To determine the RIV, for example, a device may use the length of the allocated resource blocks (L_{RBs}), the size of the BWP (N_{BWP}^{size}), and the starting resource block (RBₛₜₐᵣₜ), such that:

if (L_{RBs}−1)≤└N_{BWP}^{size}/2┘, then

RIV=N_{BWP}^{size}(L_{RBs}−1)+RBₛₜₐᵣₜ, else

RIV=N_{BWP}^{size}(N_{BWP}^{size}−L_{RBs}+1)+(N_{BWP}^{size}−1−RBₛₜₐᵣₜ).

In some examples, the RIV may include a start and length indicator value (SLIV) for consecutive resource allocation. The SLIV used for resource allocation may rely on the starting resource block of a physical resource block (PRB), but the starting resource block may not be available because it overlaps with the one or more sub-bands of the full-duplex slot. Further, if there is repetition between two different slot types (e.g., half-duplex and full-duplex), the first resource block may be counted differently to avoid falling in another sub-band not meant for transmission.

Additionally, or alternatively, in cases that the BWP 230 at least partially overlaps with multiple sub-bands, not all of the resources in the BWP may be available for resource allocation (e.g., if allocating resources for uplink communications, the portions of the BWP that overlap with a downlink sub-band within the slot may not be available for use, and vice versa). Also, with the change in duplexity of the slots (e.g., from half-duplex to full-duplex), changing the BWP size to increase the quantity of available resources may not be practical or efficient (e.g., due to increased signaling for indicating a BWP change).

If a CORESET spans an uplink subband of an SBFD slot, without a mechanism for determining how to address downlink signaling on an uplink subband, a UE 115 may ignore (e.g., not monitor) any CORESET that overlaps with an uplink subband. However, such techniques may result in failure to receive control signaling, increased retransmissions, inefficient use of available system resources, increased system latency, decreased flexibility, and decreased user experience. Instead, as described herein, the UE may support partial or complete monitoring of CORESETs that overlap with an uplink subband (e.g., the uplink subband and the guard band).

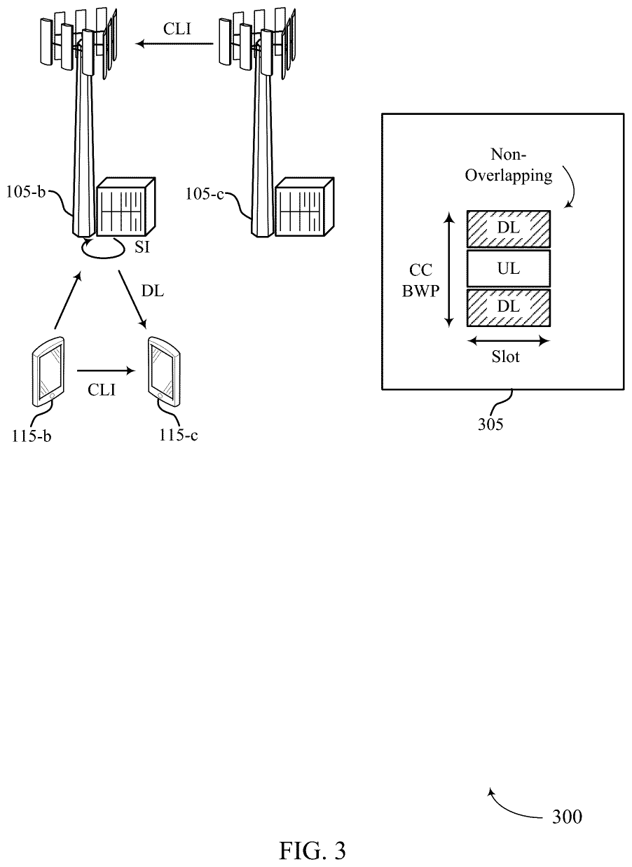

FIG. 3 illustrates an example of a wireless communications system 300 that supports control channel reception in full duplex time intervals in accordance with one or more aspects of the present disclosure. For example, wireless communications system 300 may support full-duplex communications at network entity 105-b, and half-duplex communications at UEs 115-b and 115-c. For example, the network entity 105-b or 105-c may support or otherwise be configured to receive or otherwise obtain an uplink (UL) transmission from UE 115-b or UE 115-c, and at the same time, perform a downlink (DL) transmission the UE 115-b, the UE 115-c, or both. In some examples, the network entity 105-b may perform a downlink transmission to UE 115-b, which may be a neighboring UE with respect to UE 115-c (e.g., at the same time or at a different time as performing the downlink transmission to UE 115-c).

In some examples, the full-duplex communications may include sub-band full-duplex (SBFD) (also referred to as “flexible duplex”) where the same time resources (e.g., within a slot) are used, but different frequency resources (e.g., within the BWP (BW) of a CC) are used for the communications. For example, the downlink and uplink communications may share the same time resources (e.g., the communications may be performed at the same time, at least to some degree), and the uplink communications may use different frequency resources than the downlink communications. One example of such SBFD may include non-overlapping configuration 305 where the uplink and downlink communications are performed at the same time, but using different frequency resources. In some aspects, the downlink resources (e.g., the frequency resources used for the downlink communications) may be separated from the uplink resources (e.g., the frequency resources used for the uplink communications) in the frequency domain (e.g., there may be a frequency gap between uplink frequency resources and downlink frequency resources). In some examples, the UEs 115-b and 115-c may experience cross-link interference (CLI) with one another, and the network entities 105-b and 105-c may also experience CLI with one another. Additionally, or alternatively, the full-duplex network entity 105-b may experience self-interference (SI) based on the uplink and downlink signaling performed simultaneously.

In some examples, the network entity 105-b may allocate a quantity of resources based on information associated with a configured BWP that may be associated with the full-duplex slot. For example, using FDRA, the network may support disjoint resource block allocation, or consecutive resource block allocation.

If a CORESET spans an uplink subband of an SBFD slot, without a mechanism for determining how to address downlink signaling on an uplink subband, a UE 115 may ignore (e.g., not monitor) any CORESET that overlaps with an uplink subband. However, such techniques may result in failure to receive control signaling, increased retransmissions, inefficient use of available system resources, increased system latency, decreased flexibility, and decreased user experience. Instead, as described herein, the UE may support partial or complete monitoring of CORESETs that overlap with an uplink subband.

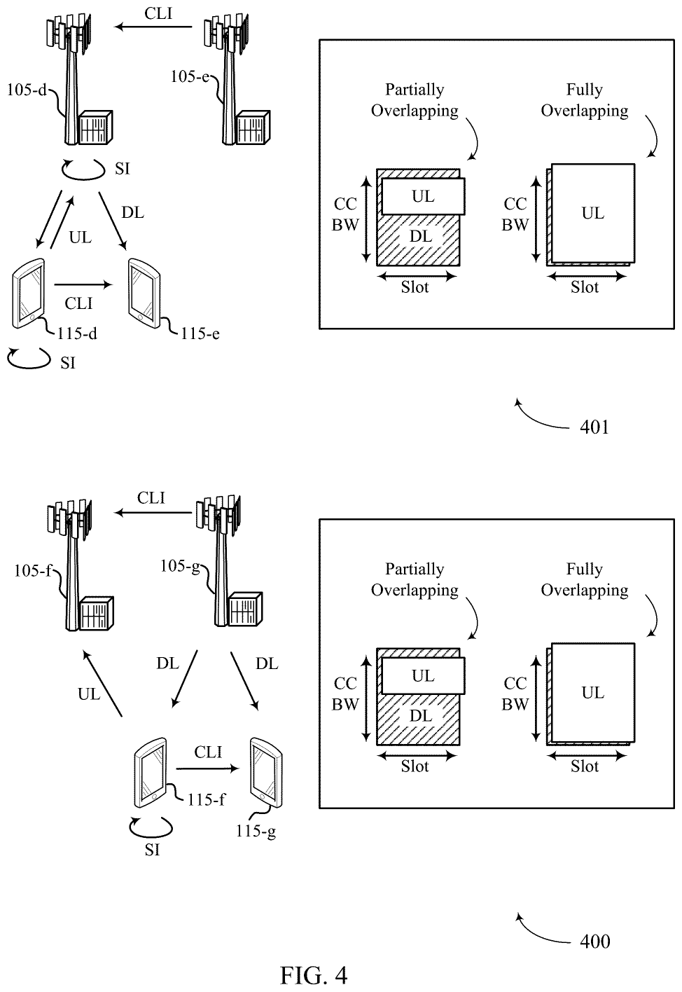

FIG. 4 illustrates an example of wireless communications systems 400 and 401 that supports control channel reception in full duplex time intervals in accordance with one or more aspects of the present disclosure. For example, wireless communications system 400 may support full-duplex communications at network entities 105-d and 105-e, as well as at UE 115-d, and half-duplex communications at UE 115-e. For example, the network entity 105-d or 105-e may support or otherwise be configured to receive or otherwise obtain an uplink (UL) transmission from UE 115-d or UE 115-e, and at the same time, perform a downlink (DL) transmission the UE 115-d, the UE 115-e, or both. In some examples, the network entity 105-d may perform a downlink transmission to UE 115-d, which may be a neighboring UE with respect to UE 115-e (e.g., at the same time or at a different time as performing the downlink transmission to UE 115-e).

Wireless communications system 401 may support full-duplex communications at network entities 105-f and 105-g, as well as at UEs 115-f and 115-g. In some examples, the network entities 105-f and 105-g may be full-duplex-capable network entities, and UEs 115-f and 115-g may be SBFD-capable UEs. For example, the network entity 105-f or 105-g may support or otherwise be configured to receive or otherwise obtain an uplink (UL) transmission from UE 115-f or UE 115-g, and at the same time, perform a downlink (DL) transmission the UE 115-f, the UE 115-g, or both. In some examples, the network entity 105-g may perform downlink transmissions to UEs 115-f and 115-g, while the UE 115-f transmits an uplink message to the network entity 105-f.

A slot format may generally be defined as a downlink-plus-uplink slot in which the band (e.g., frequency resources) is used for both uplink and downlink communications. The downlink and uplink communications may occur in overlapping bands (e.g., IBFD) or in adjacent bands (e.g., SBFD). In a given symbol of a downlink-plus-uplink slot, a UE supporting half-duplex communications may either perform an uplink transmission in the uplink frequency resources or receive a downlink transmission in the downlink frequency resources. In a given symbol of a downlink-plus-uplink slot, a UE supporting full-duplex communications may both perform an uplink transmission in the uplink frequency resources and/or receive a downlink transmission in the downlink frequency resources. A given downlink-plus-uplink slot may include downlink-only symbols, uplink-only symbols, or full-duplex symbols.

However, communications within any wireless communication system are generally associated with introducing interference into the network. That is, any device within wireless communications systems 400 and 401 performing a transmission introduces at least some degree of interference into the network (e.g., interference that may then impact and/or must then be mitigated by other devices within the network). Two non-limiting examples of such interference include CLI and SI.

CLI is broadly defined as interference caused by or otherwise introduced into the network by another device performing a wireless transmission. For example, inter-cell interference may be caused by or otherwise associated with CLI caused by other network entities. For example, network entity 105-d may introduce inter-cell interference from the perspective of network entity 105-e when network entity 105-d performs the downlink transmissions to UE 115-d and/or UE 115-e. Intra-cell CLI may generally be associated with interference from UEs within the same cell where inter-cell CLI may generally be associated with interference from UEs in adjacent cells. For example, UE 115-d may introduce CLI (e.g., intra-cell or inter-cell CLI) into the network from the perspective UE 115-e when performing the uplink transmission to network entity 105-d.

SI is broadly defined as interference caused to a device by that device performing full-duplex communications. That is, a device (such as UE 115-d) configured to or otherwise supporting performing full-duplex communications may include separate transmit and receive chains (including antenna(s)) enabling the device to perform a transmission while also receiving a different transmission. The transmission being performed introduces SI into the receive chain (e.g., including antenna(s)) being used to receive the transmission.

If a CORESET spans an uplink subband of an SBFD slot, without a mechanism for determining how to address downlink signaling on an uplink subband, a UE 115 may ignore (e.g., not monitor) any CORESET that overlaps with an uplink subband. However, such techniques may result in failure to receive control signaling, increased retransmissions, inefficient use of available system resources, increased system latency, decreased flexibility, and decreased user experience. Instead, as described herein, the UE may support partial or complete monitoring of CORESETs that overlap with an uplink subband.

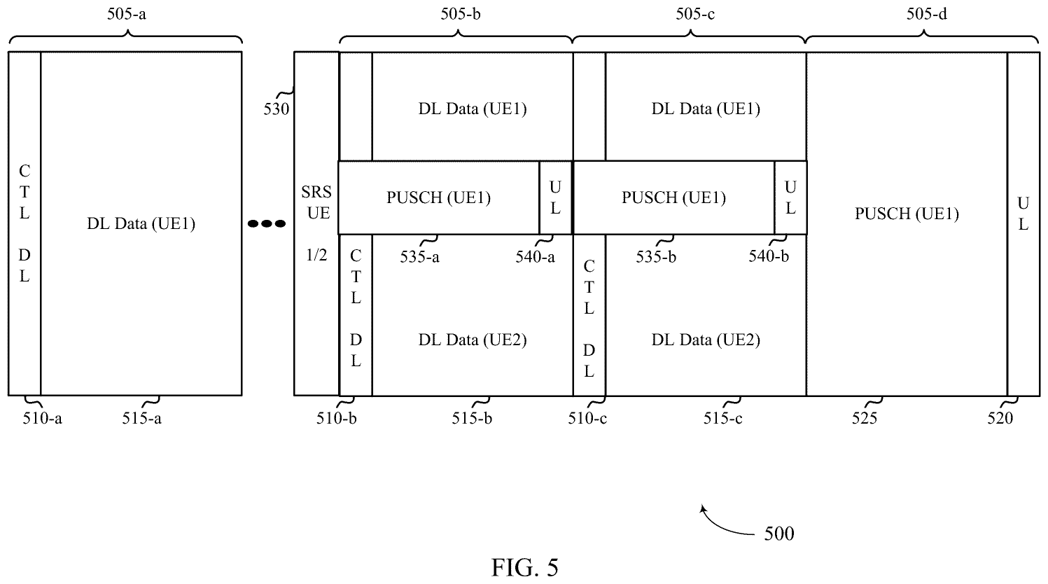

FIG. 5 illustrates an example of a duplexing configuration 500 that supports control channel reception in full duplex time intervals in accordance with one or more aspects of the present disclosure. Duplexing configuration 500 illustrates an example of duplexing operations that may be adopted in accordance with the techniques described herein. For example, multiple slots 505 may be available for communications between a UE and a network entity as described with reference to FIGS. 1-4. In some examples, the duplexing configuration 500 may be used to support the techniques for determining the first available resource block and the effective BWP size as described herein.

Each slot 505 may generally include a control (CTL) portion (e.g., a physical downlink control channel (PDCCH) used for communicating control information, such as DCI communications) and a data portion (e.g., a PDSCH used for communicating data). Slot 505-a provides an example of a downlink slot where the control portion 510-a comprises a downlink control portion (e.g., PDCCH) and data portion 515-a comprises a downlink data portion (e.g., PDSCH). For downlink slots 505, the control portion occurs at the beginning of the slot 505 (e.g., the first two or three symbols) while the data portion 515-a uses most or all of the remaining symbols in the slot (there may be one or more gap symbols within the data portion 515). Slot 505-d comprises an example of an uplink slot where the control portion 520 occurs in the last two or three symbols of the slot 505 and the data portion 525 occurs in the remaining symbols of the slot 505. Moreover, some slots 505 may include one or more portions 530 where UE (such as a first UE, UE1, and a second UE, UE2) perform sounding reference signal (SRS) transmissions to sound the channel.

In some examples, slot 505-b and slot 505-c illustrate examples of flexible duplexing (e.g., downlink-plus-uplink) slots. In particular, slot 505-b and slot 505-c illustrate examples of SBFD slots supporting full-duplex communications using uplink resources (e.g., PUSCH) as well as using downlink resources (e.g., PDSCH). For example, the time resources may overlap in the time domain in the SBFD scenario while the frequency resources used for downlink transmissions are different from the frequency resources used for uplink transmissions. In some examples, the downlink and uplink transmissions may occur in overlapping bands (e.g., IBFD) or adjacent bands (e.g., SBFD). In a given downlink-plus-uplink symbol, a UE configured for half-duplex communications may either transmit communications in the uplink band or receive in the downlink band. Additionally, or alternatively, a UE configured for full-duplex communications may transmit in the uplink band and/or receive in the downlink band in the same slot. In some cases, a downlink-plus-uplink slot may include downlink symbols, uplink symbols, or full-duplex symbols.

In some examples, slot 505-b including a first portion of downlink frequency resources allocated to downlink transmissions to the first UE (e.g., PDSCH for UE1) and a second portion of downlink frequency resources allocated to downlink transmissions to the second UE (e.g., PDSCH for UE2). Slot 505-b may include control portion 510-b and data portion 515-b. Slot 505-b may also include a set of uplink frequency resources, that may optionally include both a data portion 535-a (e.g., used for communicating uplink data) and a control portion 540-a (e.g., used for communicating scheduling requests (SR) transmissions, buffer status report (BSR) transmissions, uplink control information (UCI) transmissions, etc.).

In some other examples, the slot 505-c including a first portion of downlink frequency resources allocated to downlink transmissions to the first UE (e.g., PDSCH for UE1) and a second portion of downlink frequency resources allocated to downlink transmissions to the second UE (e.g., PDSCH for UE2). Slot 505-c may include a control portion 510-c and a data portion 515-c. Slot 505-c may also include a set of uplink frequency resources, that may optionally include both a data portion 535-b and a control portion 540-b.

If a CORESET spans an uplink subband of an SBFD slot, without a mechanism for determining how to address downlink signaling on an uplink subband, a UE 115 may ignore (e.g., not monitor) any CORESET that overlaps with an uplink subband. However, such techniques may result in failure to receive control signaling, increased retransmissions, inefficient use of available system resources, increased system latency, decreased flexibility, and decreased user experience. Instead, as described herein, the UE may support partial or complete monitoring of CORESETs that overlap with an uplink subband.

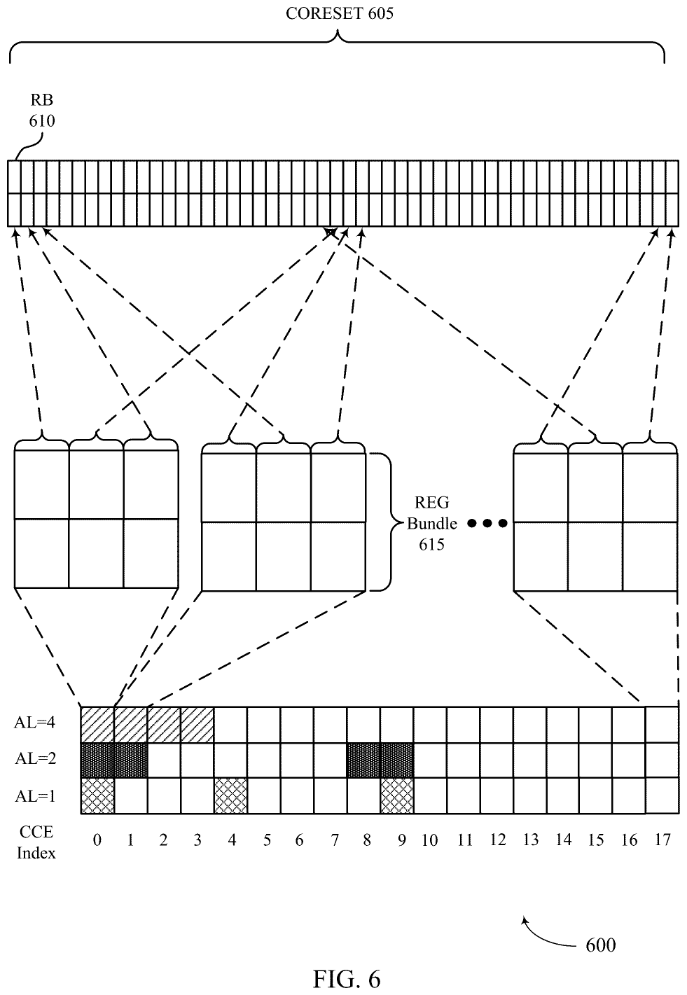

FIG. 6 illustrates an example of a resource configuration 600 that supports control channel reception in full duplex time intervals in accordance with one or more aspects of the present disclosure. The resource configuration 600 may implement aspects of, or be implemented by aspects of, wireless communications systems 100, 200, 300, 400, and 401, as well as duplexing configuration 500. For example, one or more network entities (e.g., network entities 105) and one or more UEs (e.g., UEs 115), which may be examples of corresponding devices described with reference to FIGS. 1-5, may communicate according to the resource configuration 600.

In some examples, a network entity may configure a UE with a CORESET 605. A CORESET 605 may define frequency domain RBs (e.g., RBs 610) and time domain duration (e.g., a number of consecutive symbols) of a control region of a PDCCH. A CORESET 605 may be a CORESET 0 (e.g., a CORESET 605 with an identifier ID=0, configured via system information such as a master information block (MIB)), or may be a CORESET with a non-zero ID. Each CORESET 605 may be associated with one or more search spaces (e.g., of a search space set). The search space set may define a slot pattern and starting symbol of a control region in each slot of the pattern. The UE may determine the slot for monitoring a search space set based on one or more parameters (e.g., a periodicity k, an offset o, a duration of T, wherein T<k. Search space sets may be one of various types of search space sets, such as Type® PDDCH common search space (CSS) sets (e.g., for PDCCH scheduling system information block 1 (SIB1)), Type0A PDCCH CSS set (e.g., for PDCCH scheduling other system information (OSI)), Type1 PDCCH CSS sets (e.g., for PDCCH related to random access), Type 2 PDCCH CSS sets (e.g., for PDCCH scheduling page messages), Type 3 PDCCH CSS sets (e.g., for all other PDCCHs monitored in CSS), UE specific search space (USS) sets (e.g., for PDCCH scheduling UE specific data), among other examples. In some examples, a threshold number of CORESETs 605, and a threshold number of search space sets may be supported in an active BWP configured at the UE.

In some examples, the CORESET 605 may be associated with (e.g., defined by) a frequency location, which may be determined by a bitmap (e.g., of size 45, where each bit represents a number of resource element groups (REGs) per CCE, such as 1 bit represents 6 REGs=6RBs=1 CCE). The CORESET 605 may similarly be defined by an RB offset (e.g., a higher layer parameter such as rb-offset-r16=1, . . . , 5), which may indicate a shift from a first RB 610 in the BWP.

A CORESET 605 may include one or more PDCCH candidates. For example, the CORESET 605 may include one or more monitoring occasions (e.g., the time and frequency resources defined by the CORESET 605). The UE may determine which time and frequency resources to actually monitor (e.g., may identify one or more PDCCH candidates). In some examples, PDCCH candidates may be consecutive (e.g., a subset of consecutive RBs 610 within the CORESET 605 may be identified as PDCCH candidates).

PDCCH candidates may be interleaved, where one or more CCEs may be mapped to non-consecutive RBs 610. Each CCE may correspond to a CCE index, and may be defined by one or more REG bundles 615. Each REG bundle 615 may be defined by an REG bundle size, and may accordingly include one or more REGs. The interleaving may be defined by one or more parameters, such as an REG bundle size (e.g., 2, 3, or 6, among other examples), an interleaver size (e.g., 2, 3, or 6, among other examples), and shift index (e.g., which may define an initial CCE index of multiple CCE indices associated with the CORESET 605). For instance, for a CORESET size of 54 RBs and two symbols (e.g., CORESET 605), and n interleave size of 2, an REG bundle size of 2 (e.g., two REGs in each REG bundle 615), and a shift of 0, as illustrated with reference to FIG. 6, the UE may perform a 27×2 block interleave for 54 REG bundles. Each CCE may be mapped to multiple (e.g., consecutive or non-consecutive) RBs of the CORESET 605. For instance, a first REG bundle 615 of a first CCE 0 may map to the first RB 610 of the CORESET 605, a second REG 615 of the CCE 0 may map to another non-consecutive RB 610 (e.g., a 27th RB 610 of the CORESET 605), and a third REG bundle 615 of the CCE 0 may map to a second RB 610 of the CORESET 605. Similarly, for CCE 1, a first REG bundle 615 may map to a 28th RB 610, a second REG bundle 615 may map to a third RB 610, and a third REG bundle 615 may map to a 29th RB 610. The CCEs associated with each CCE index may similarly map to the RBs 610 of the CORESET 605, such that for CCE 17, a first REG bundle 615 may map to a 53rd RB 610, a second REG bundle 615 may map to a 26th RB 610, and a third REG bundle 615 may map to a 54th RB 610.

PDCCH candidates of the CORESET 605 may also be defined by aggregation levels. Aggregation levels may indicate number of CCEs in a PDCCH candidate. Aggregation levels may include AL=1, AL=2, AL=4, etc., as illustrated with reference to FIG. 6. In some examples, search spaces may be configured via higher layer signaling (e.g., an information element sch as SearchSpace), which may define where and how to search for PDCCH candidates (e.g., may indicate which resources the UE is to monitor for downlink control signaling). Each search space may be associated with a CORESET 605. The higher layer signaling (e.g., SearchSpace information element) may define a periodicity and offset of a PDCCH candidate or search space (e.g., SI4=2 may indicate that the UE is to monitor the third slot ever four slots), a duration (e.g., a number of slots in each monitoring occasion or PDCCH candidate), and an aggregation level (e.g., AL=2 may indicate two CCEs), and may also indicate which aggregation levels are supported and a corresponding number of PDCCH decoding candidates. The location of PDCCH candidates relative to CCE indices may be determined by a hash-function.

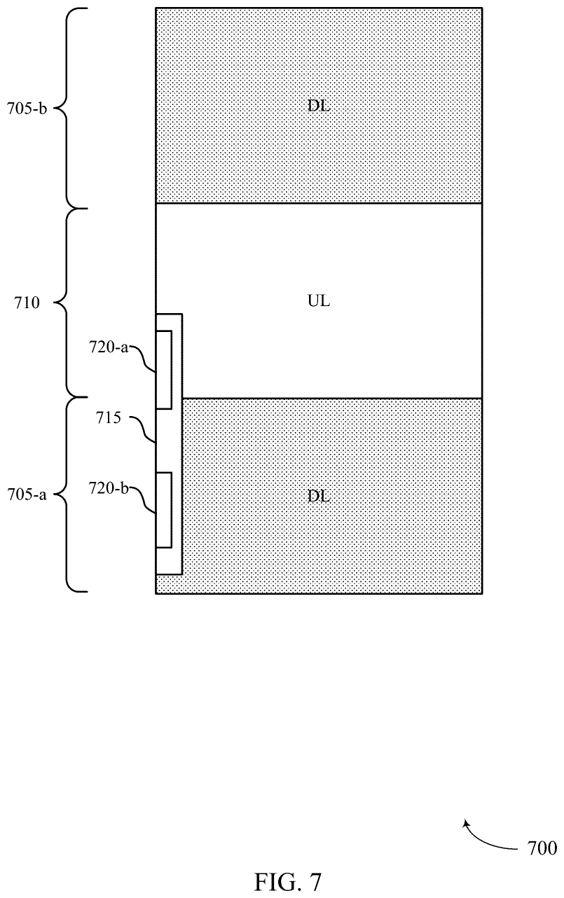

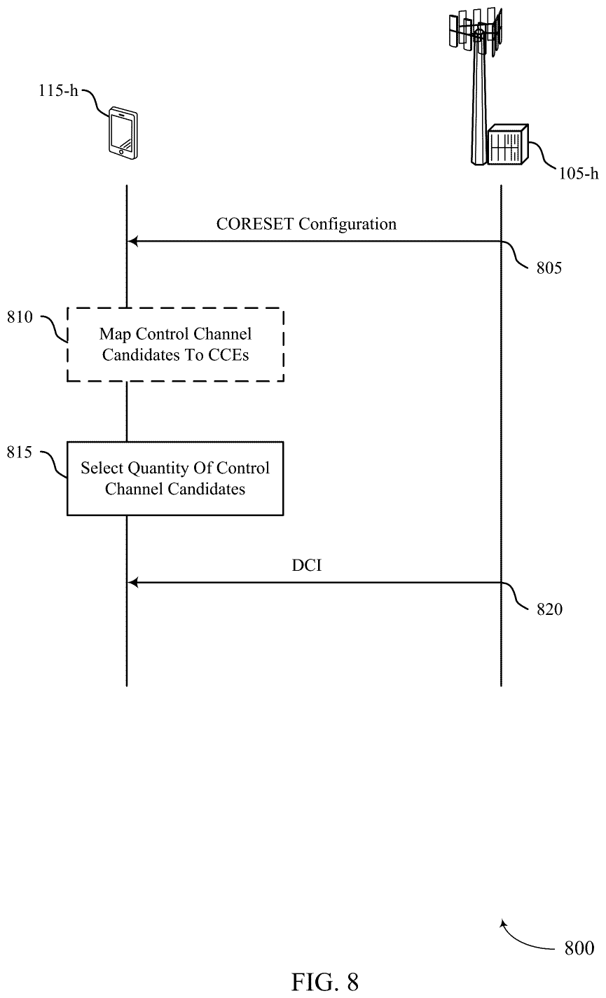

Thus, as described with reference to FIG. 6, the CORESET 605 may be configured to span a range of RBs 610, but the UE may determine which resources of the CORESET 605 to monitor by identifying one or more PDCCH candidates, and monitoring toe identified PDCCH candidates. However, as described in greater detail with reference to FIGS. 7 and 8, in some examples, the CORESET 605 may at least partially overlap with an uplink subband of an SBFD time interval (e.g., slot). In such examples, some PDCCH candidates (e.g. for monitoring for and receiving downlink control signaling) may be located on uplink resources of the uplink subband. Ignoring such CORESETs 605 based on the partial overlap may result in failed signaling, inefficiency use of available system resources, increased system latency, decreased throughput, and decreased user experience. Techniques described herein may support partial or complete monitoring of PDCCH candidates in a CORESET 605 that at least partially overlaps in frequency with an uplink subband.

FIG. 7 illustrates an example of a resource configuration 700 that supports control channel reception in full duplex time intervals in accordance with one or more aspects of the present disclosure. The resource configuration 700 may implement aspects of, or be implemented by aspects of, wireless communications systems 100, 200, 300, 400, and 401, as well as duplexing configuration 500. For example, one or more network entities (e.g., network entities 105) and one or more UEs (e.g., UEs 115), which may be examples of corresponding devices described with reference to FIGS. 1-6, may communicate according to the resource configuration 700.

In some examples, a UE may support communications via SBFD slots, as illustrated with reference to FIG. 7. For example, in a SBFD slot, the UE may downlink communications via the downlink subband 705-a and the downlink subband 705-b, and may support uplink communications via the uplink subband 710. The UE may also be configured with a CORESET 715, as described in greater detail with reference to FIG. 6. The CORESET 715 may overlap at least partially in frequency with the uplink subband 710, in which case one or more PDCCH candidates 720 (e.g., the PDCCH candidate 720-a) may also overlap at least partially with the uplink subband 710.

In some examples, the UE may refrain from monitoring any monitoring occasions during SBFD slots in which the CORESET 715 overlaps with any uplink resources (e.g., any portion of the uplink subband 710). However, such techniques may lead to limitations of CORESET configurations in SBFD slots. Additionally, or alternatively, such techniques may result in failed signaling, inefficiency use of available system resources, increased system latency, decreased throughput, and decreased user experience.

Techniques described herein may support partial or complete monitoring of PDCCH candidates 720 that overlap with uplink subbands 710. In some examples, the UE (e.g., an SBFD aware UE) may support (e.g., does expect to be scheduled with) downlink reception via an uplink subband in an SBFD symbol. In such examples, the UE may (e.g., according to one or more rules or conditions) monitoring some PDCCH candidates 720 (e.g., PDCCH candidate 720-b) that are located within a downlink subband 705. In some examples, the UE (e.g., an SBFD aware UE) may be scheduled with downlink reception in an uplink subband 710 of an SBFD symbol. As described with reference to FIG. 6, in a given monitoring occasion (e.g., of a CORESET 715), the location of PDCCH candidates within the CORESET 715 may depend on multiple factors (e.g., whether interleaving is on or off, and the interleaving parameters, which aggregation levels are supported in a given search space and associated DCI format, among other examples). The UE may implement hash-function mapping of PDCCH candidates to CCE indices. The UE may also determine which mapped PDCCH candidates to monitor, as described herein.

The UE may not support (e.g., may not be expected to perform) receiving downlink signals overlapping with an uplink subband 710. However, instead of dropping such monitoring occasions (e.g., instead of dropping the entire CORESET 715), the UE may support partial monitoring of PDCCH candidates within the CORESET 715 under certain conditions. For example, mapping of PDCCH candidates of a certain search space to CCEs of the associated CORESET may be restricted based on a threshold number (e.g., quantity) of PDCCH candidates. For instance, an allowed (e.g., supported) number of PDCCH candidates may satisfy a threshold quantity of PDCCH candidates (e.g., aggregation level multiplied by a fixed value such as a number of REGs per CCE, such as AL·6 or 4·6=24 for aggregation level 4), such that a number of RBs in intersection of the CORESET with the downlink subband is greater than or equal to the threshold (e.g., AL·6). In such examples, a number of PDCCH candidates 720 located in the downlink subband 705-a may satisfy the threshold, such that a quantity of PDCCH candidates that the UE monitors satisfy the threshold (e.g., increasing the likelihood of successfully receiving downlink control signaling via the CORESET 715, despite the overlap with the uplink subband 710). For instance, a number of PDCCH candidates 720-b (e.g., located in the downlink subband 705-a) may satisfy the threshold, and the UE may monitor the PDCCH candidates 720-b (e.g., and ignore or refrain from monitoring the PDCCH candidates 720-a that are located in the uplink subband 710).

In some examples, the network entity and the UE may not support interleaving (e.g., interleaving may be turned off or may not be enabled) for SBFD slots. For example, the UE may support non-interleaved CCE to REG mapping with REG bundles (e.g., REG bundle size=6). The CORESET 715 associated with a search space which has monitoring occasions overlapping with the uplink subband 710 (e.g., one or more PDCCH candidates 720-a) may not be configured with interleaving. In such examples, the PDCCH candidates 720 may be consecutive (e.g., may correspond to consecutive CCEs, and not interleaved CCEs). This may simply the monitoring at the UE for SBFD slots. For instance, the UE may check if a PDCCH candidate is located in the downlink subband. The UE may monitor PDCCH candidates that are located in the downlink subband 705-a (e.g., the PDCCH candidate 720-b), and may ignore (e.g., refrain from monitoring, or may not be configured with) PDCCH candidates that are located in the uplink subband 710.

In some examples, the UE may support interleaving of PDCCH candidates 720. However, the UE may not be expected to monitor (e.g., may refrain from monitoring) PDCCH candidates 720-a that overlap with the uplink subband 710 after the interleaving. For example, the UE may receive configuring information (e.g., via control signaling) indicating one or more parameters for the CORESET 715, which may enable (e.g., turn on) interleaving for the CORESET 715 and may indicate an interleaving pattern (e.g., as described in greater detail with reference to FIG. 6). The UE may perform a mapping to determine interleaved PDCCH candidates 720. However, the UE may consider only candidates that do not overlap with the uplink subband 710 (e.g., PDCCH candidates 720-b) as valid (e.g., and may ignore any PDCCH candidates 720-a that overlap with the uplink subband 710). In some examples, such rules or conditions may place one or more conditions or restrictions on the configuration of higher layer parameters (e.g., CORESET configuration, including supported interleaving parameters, CORESET size, CORESET location, among other examples). Additionally, or alternatively, the UE may support search space configuration (e.g., SS config) that supports specific aggregation levels (e.g., for the UE to support interleaving, but to ignore PDCCH candidates 720-a that overlap with the uplink subband 710.

In some examples, the UE may support an interleaving function that is defined for SBFD slots. Such an interleaving function may be based on an input of a total number of available frequency resources (e.g., a total number of available RBs) in a CORESET 715 (e.g., resulting in exclusion of RBs outside of downlink subbands 705 in the interleaving pattern). For example, the network may configure the UE with a first interleaving pattern (e.g., a first set of interleaving parameters or inputs including the full range of frequency resources of the CORESET 715) and a second interleaving pattern (e.g., a second set of interleaving parameters or inputs including a smaller range of frequency resources that include one or more downlink subbands 705, but do not include any frequency resources of any uplink subbands 710). In such examples, the UE may receive the configuration information for the CORESET 715, and may determine that the CORESET 715 is located in an SBFD subband. In such examples, the UE may select the second interleaving pattern (e.g., based on an indication from the network that interleaving is enabled or turned on for the SBFD subband or the CORESET 715), and may perform CCE mapping to identify PDCCH candidates 720-b (e.g., that do not overlap with the uplink subband 710). In some examples, such an interleaving pattern may be defined in one or more standards documents. In some cases, the UE may apply the second interleaving pattern autonomously (e.g., without additional configuration or instruction from the network).

The UE may support monitoring of downlink signaling that overlaps with uplink subbands 710 (e.g., in an SBFD slot). In such cases, the UE may be scheduled to monitor CORESETs 715 that overlap with uplink subbands 710. In some examples, the UE may be scheduled for any type of PDDCH monitoring (e.g., via common CORESETs, dedicated CORESETs, etc.) overlapping with the uplink subband 710. The UE may assume (e.g., determine, based on one or more rules, or based on an explicit indication from the network) that symbols containing CORESETs 715 are downlink symbols (e.g., even if the symbols of the CORESET 715 overlap with uplink subbands 710). In such examples, the UE may determine that the one or more symbols associate with the CORESET 715 are downlink symbols, and may therefore monitor for downlink control signaling during PDCCH candidates 720-b (e.g., that do not overlap with the uplink subband 710) and during PDCCH candidates 720-a (e.g., during downlink symbols of the CORESET 715 of the uplink subband 710).

In some examples, the UE may determine that the symbols of the CORESET 715 are downlink symbols (e.g., even for the uplink subband 710) based on one or more rules associated with the frequency range of the coreset 715. For instance, the UE may assume that the symbols containing CORESET 715 are downlink symbols only for a CORESET 715 that is partially overlapping with an uplink subband 710. In some examples, the UE may assume that the symbols containing CORESET 715 are downlink symbols for a CORESET 715 that is partially overlapping or completely overlapping with an uplink subband 710 (e.g., the entire CORESET is located in the uplink subband 710, but the symbols of the CORESET are considered downlink symbols).

The UE may support downlink signaling during downlink symbols of the uplink subband 710 for specific (e.g., some, but not all) PDCCHs. For instance, the UE may support monitoring of PDCCH candidates 720 during an uplink subband 710 for specific PDCCHs. The UE may be scheduled with such specific PDCCHs that overlap with the subband. For instance, the UE may support monitoring PDCCH candidates 720 of a CORESET0 that overlap with the uplink subband 710 (e.g., but may not support monitoring of PDCCH candidates 720 for other CORESETs with non-zero IDs). Similarly, the UE may support monitoring PDCCH candidates 720 of a CORESET that is a common CORESET that overlap with the uplink subband 710 (e.g., but may not support monitoring of PDCCH candidates 720 for CORESET0). In such examples, the network may configure the UE with a CORESET type (e.g., may configure a CORESET0 or another CORESET) and the UE may determine, based on the type of CORESET, whether to monitor PDCCH candidates 720 in the uplink subband 710. In some cases, the network may transmit an explicit instruction to monitor or not monitor PDCCH candidates or types of CORESETs in the uplink subband 710 (e.g., the network may indicate a type of CORESET that the UE is to monitor in the uplink subband 710). in some examples, the UE may monitor PDCCH candidates 720 in uplink subbands for specific search spaces. For example, the network may indicate (e.g., via an RRC g, such as an RRC parameter such as SS config) one or more search spaces or search space sets, or one or more PDCCH candidates 720 for which monitoring is permitted during uplink subbands 710.

In some examples, the UE may identify (e.g., based on control signaling) a relationship (e.g., an association) between search spaces and downlink subbands (e.g., during those search spaces the UE may or may not monitor for downlink signaling on downlink or corresponding uplink subbands). In some examples, the UE may identify (e.g., based on control signaling) a priority rule for search spaces to include duplex mode (e.g., for an SBFD slot). The UE ay first look at a duplex mode, then an index to determine monitoring of PDCCH candidates.

FIG. 8 illustrates an example of a process flow 800 that supports control channel reception in full duplex time intervals in accordance with one or more aspects of the present disclosure. The process flow 800 may include a network entity 105-h and a UE 115-h, which may be examples of corresponding devices described with reference to FIGS. 1-7.

At 805, the UE 115-e may receive (e.g., from the network entity 105-h), control signaling (e.g., higher layer signaling such as RRC signaling). The Control signaling may include CORESET configuration information (e.g., as described in greater detail with reference to FIGS. 6-7). The control signaling may indicate a CORESET during a full duplex slot, the CORESET including multiple control channel candidates (e.g., PDCCH candidates) associated with a downlink control channel, wherein the CORESET at least partially overlaps in frequency with an uplink subband of a SBFD slot.

At 815, the UE 115-h may select, for monitoring by the UE during the SBFD slot, a quantity of control channel candidates from the multiple control channel candidates of the CORESET that at least partially overlaps in frequency with the uplink subband.

At 820, the UE 115-h may receive (e.g., from the network entity 105-h) one or more DCI messages via the selected quantity of control channel candidates based at least in part on monitoring one or more search spaces of the selected quantity of control channel candidates. The selected quantity of control channel candidates may be located in a downlink subband of the SBFD slot. The selecting may include excluding a second quantity of control channel candidates from the multiple of control channel candidates that are located in the uplink subband.

In some examples, the UE 115-h may not support monitoring of control channel candidates on uplink subbands. In such examples, the selected quantity of control channel candidates may satisfy a threshold quantity of control channel candidates associated with a quantity of frequency resources corresponding to the downlink subband, and the selecting at 815 may be based at least in part on the quantity of control channel candidates satisfying the threshold quantity of control channel candidates.

In some examples, the UE 115-h may map the control channel candidates to consecutive CCEs based at least in part on the control signaling. A first subset of the multiple consecutive CCEs corresponding to the selected quantity of control channel candidates may be located in the downlink subband and a second subset of the consecutive CCEs may be located in the uplink subband. The receiving may be based least in part on the mapping (e.g., the UE may receive the DCIs at 820 via the quantity of control channel candidates located on the downlink subband (e.g., and not the uplink subband) according to the mapping).

In some examples, the UE 115-h may map the control channel candidates to multiple interleaved CCEs based at least in part on the control signaling. The first subset of the interleaved CCEs corresponding to the selected quantity of control channel candidates may be located in the downlink subband and a second subset of the interleaved CCEs may be located in the uplink subband. The receiving may be based at least in part on the mapping (e.g., the UE may receive the DCIs at 820 via the quantity of control channel candidates located on the downlink subband (e.g., and not the uplink subband) according to the mapping).

In some examples, the UE may receive, via the control signaling at 805, an indication of a first interleaving pattern associated with a first set of frequency resources associated with the CORESET and a second interleaving pattern associated with a subset of the first set of frequency resources that is associated with a portion of the CORESET that overlaps with downlink subband. The UE may then, at 810, map the selected quantity of control channel candidates to interleaved CCEs in the SBFD slot based at least in part on the second interleaving pattern. The interleaved CCEs may be located in the downlink subband, and the UE 115-c may receive the one or more DCI messages at 820 based at least in part on the mapping.

In some examples, the UE 115-h may support monitoring of downlink control signaling during uplink subbands of an SBFD slot. In such examples, at 820, the UE 115-h may receive the one or more DCI messages via the selected quantity of control channel candidates based at least in part on monitoring one or more search spaces of the selected quantity of control channel candidates. A first portion of the selected quantity of control channel candidates may be located in a downlink subband of the SBFD slot and a second portion of the selected quantity of control channel candidates may be located in the uplink subband. In some examples, the UE 115-h may determine that frequency resources of the uplink subband are allocated as downlink resources (e.g., downlink symbols) during one or more time intervals associated with the second portion of the selected quantity of control channel candidates, and receiving the one or more DCI messages may be based at least in part on the determining.

In some examples, the UE 115-h may receive, via the control signaling, an indication of a type of the CORESET (e.g., CORESET 0, common CORESET, dedicated CORESET), and receiving the one or more DCI messages may be based at least in part on the type of the CORESET.

The UE 115-h may receive, via the control signaling at 805, an indication of one or more search spaces that are associated with the DCI messages (e.g., during which the UE 115-h may monitor for downlink control signaling during an uplink subband).

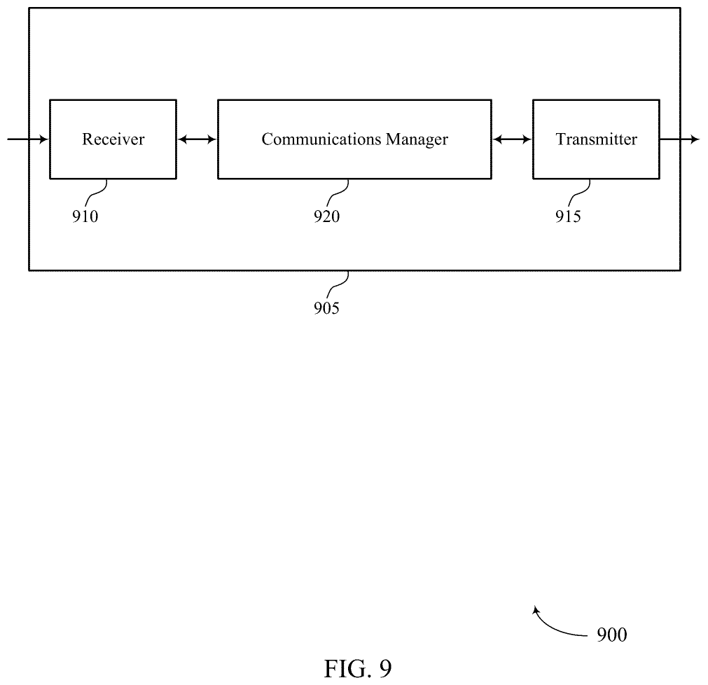

FIG. 9 shows a block diagram 900 of a device 905 that supports control channel reception in full duplex time intervals in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to control channel reception in full duplex time intervals). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to control channel reception in full duplex time intervals). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of control channel reception in full duplex time intervals as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 may be configured as or otherwise support a means for receiving control signaling indicating a CORESET during a full duplex slot, the CORESET including a set of multiple control channel candidates associated with a downlink control channel, where the CORESET at least partially overlaps in frequency with an uplink subband of a SBFD slot. The communications manager 920 may be configured as or otherwise support a means for selecting, for monitoring by the UE during the SBFD slot, a quantity of control channel candidates from the set of multiple control channel candidates of the CORESET that at least partially overlaps in frequency with the uplink subband.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for CORESET monitoring in SBFD subbands, which may result in increased reliability of control signaling, reduced retransmissions, efficient use of available system resources, decreased system latency, increased flexibility, and improved user experience.

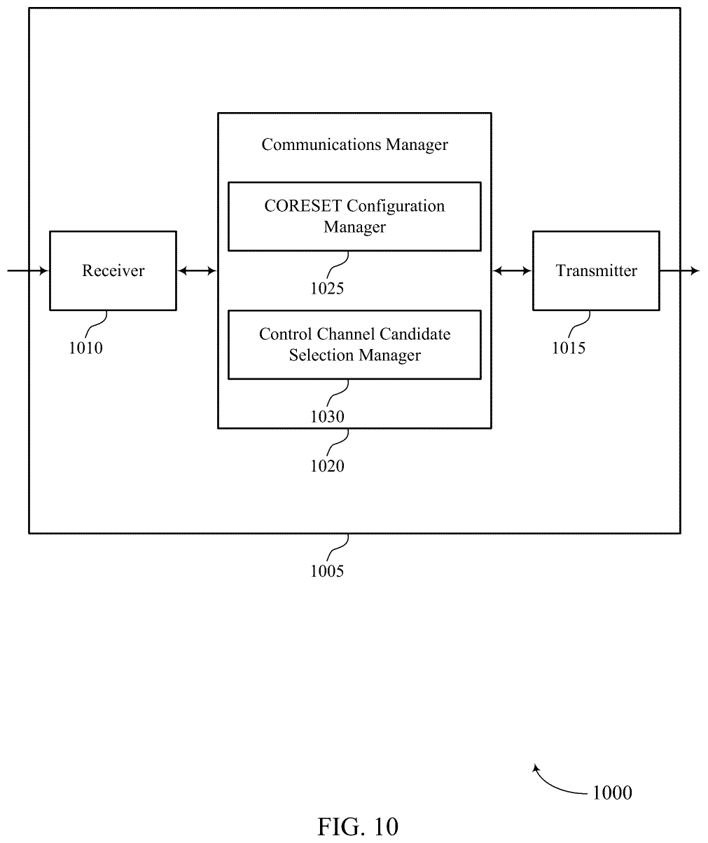

FIG. 10 shows a block diagram 1000 of a device 1005 that supports control channel reception in full duplex time intervals in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to control channel reception in full duplex time intervals). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to control channel reception in full duplex time intervals). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of control channel reception in full duplex time intervals as described herein. For example, the communications manager 1020 may include a CORESET configuration manager 1025 a control channel candidate selection manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The CORESET configuration manager 1025 may be configured as or otherwise support a means for receiving control signaling indicating a CORESET during a full duplex slot, the CORESET including a set of multiple control channel candidates associated with a downlink control channel, where the CORESET at least partially overlaps in frequency with an uplink subband of a SBFD slot. The control channel candidate selection manager 1030 may be configured as or otherwise support a means for selecting, for monitoring by the UE during the SBFD slot, a quantity of control channel candidates from the set of multiple control channel candidates of the CORESET that at least partially overlaps in frequency with the uplink subband.

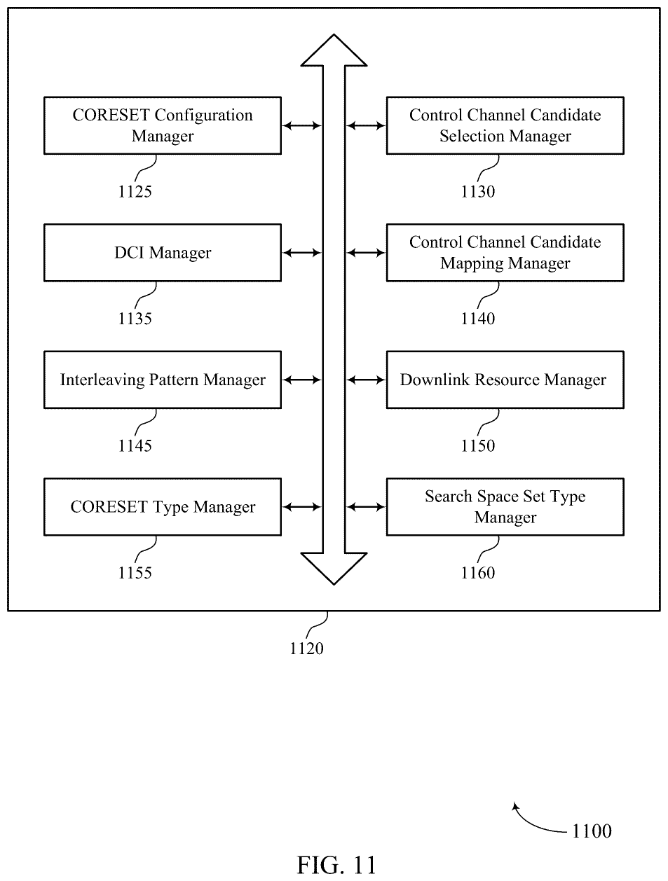

FIG. 11 shows a block diagram 1100 of a communications manager 1120 that supports control channel reception in full duplex time intervals in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of control channel reception in full duplex time intervals as described herein. For example, the communications manager 1120 may include a CORESET configuration manager 1125, a control channel candidate selection manager 1130, a DCI manager 1135, a control channel candidate mapping manager 1140, an interleaving pattern manager 1145, a downlink resource manager 1150, a CORESET type manager 1155, a search space set type manager 1160, or any combination thereof. Each of these components may communicate, directly or indirectly, with one another (e.g., via one or more buses).

The communications manager 1120 may support wireless communications at a UE in accordance with examples as disclosed herein. The CORESET configuration manager 1125 may be configured as or otherwise support a means for receiving control signaling indicating a CORESET during a full duplex slot, the CORESET including a set of multiple control channel candidates associated with a downlink control channel, where the CORESET at least partially overlaps in frequency with an uplink subband of a SBFD slot. The control channel candidate selection manager 1130 may be configured as or otherwise support a means for selecting, for monitoring by the UE during the SBFD slot, a quantity of control channel candidates from the set of multiple control channel candidates of the CORESET that at least partially overlaps in frequency with the uplink subband.

In some examples, the DCI manager 1135 may be configured as or otherwise support a means for receiving one or more downlink control information messages via the selected quantity of control channel candidates based on monitoring one or more search spaces of the selected quantity of control channel candidates, where the selected quantity of control channel candidates are located in a downlink subband of the SBFD slot, where the selecting includes excluding a second quantity of control channel candidates from the set of multiple control channel candidates that are located in the uplink subband.

In some examples, the selected quantity of control channel candidates satisfies a threshold quantity of control channel candidates associated with a quantity of frequency resources corresponding to the downlink subband, and the selecting is based on the quantity of control channel candidates satisfying the threshold quantity of control channel candidates.

In some examples, the control channel candidate mapping manager 1140 may be configured as or otherwise support a means for mapping the set of multiple control channel candidates to a set of multiple consecutive CCEs based on the control signaling, where a first subset of the set of multiple consecutive CCEs corresponding to the selected quantity of control channel candidates is located in the downlink subband and a second subset of the set of multiple consecutive CCEs is located in the uplink subband, where the receiving is based least in part on the mapping.

In some examples, the control channel candidate mapping manager 1140 may be configured as or otherwise support a means for mapping the set of multiple control channel candidates to a set of multiple interleaved CCEs based on the control signaling, where a first subset of the set of multiple interleaved CCEs corresponding to the selected quantity of control channel candidates is located in the downlink subband and a second subset of the set of multiple interleaved CCEs is located in the uplink subband, where the receiving is based on the mapping, and where the first subset of the set of multiple interleaved CCEs corresponds to the selected quantity of control channel candidates.

In some examples, the interleaving pattern manager 1145 may be configured as or otherwise support a means for receiving, via the control signaling, an indication of a first interleaving pattern associated with a first set of frequency resources associated with the CORESET and a second interleaving pattern associated with a subset of the first set of frequency resources that is associated with a portion of the CORESET that overlaps with downlink subband. In some examples, the interleaving pattern manager 1145 may be configured as or otherwise support a means for mapping the selected quantity of control channel candidates to a set of multiple interleaved CCEs in the SBFD slot based on the second interleaving pattern, where the set of multiple interleaved CCEs are located in the downlink subband, and where receiving the one or more downlink control information messages is based on the mapping.

In some examples, the DCI manager 1135 may be configured as or otherwise support a means for receiving one or more downlink control information messages via the selected quantity of control channel candidates based on monitoring one or more search spaces of the selected quantity of control channel candidates, where a first portion of the selected quantity of control channel candidates is located in a downlink subband of the SBFD slot and a second portion of the selected quantity of control channel candidates is located in the uplink subband.

In some examples, the downlink resource manager 1150 may be configured as or otherwise support a means for determining that frequency resources of the uplink subband are allocated as downlink resources during one or more time intervals associated with the second portion of the selected quantity of control channel candidates, where receiving the one or more downlink control information messages is based on the determining.

In some examples, the CORESET type manager 1155 may be configured as or otherwise support a means for receiving, via the control signaling, an indication of a type of the CORESET, where receiving the one or more downlink control information messages is based on the type of the CORESET.

In some examples, the search space set type manager 1160 may be configured as or otherwise support a means for receiving, via the control signaling, an indication of the one or more search spaces that are associated with the one or more downlink control information messages, where receiving the one or more downlink control information messages is based on the indication of the one or more search spaces.

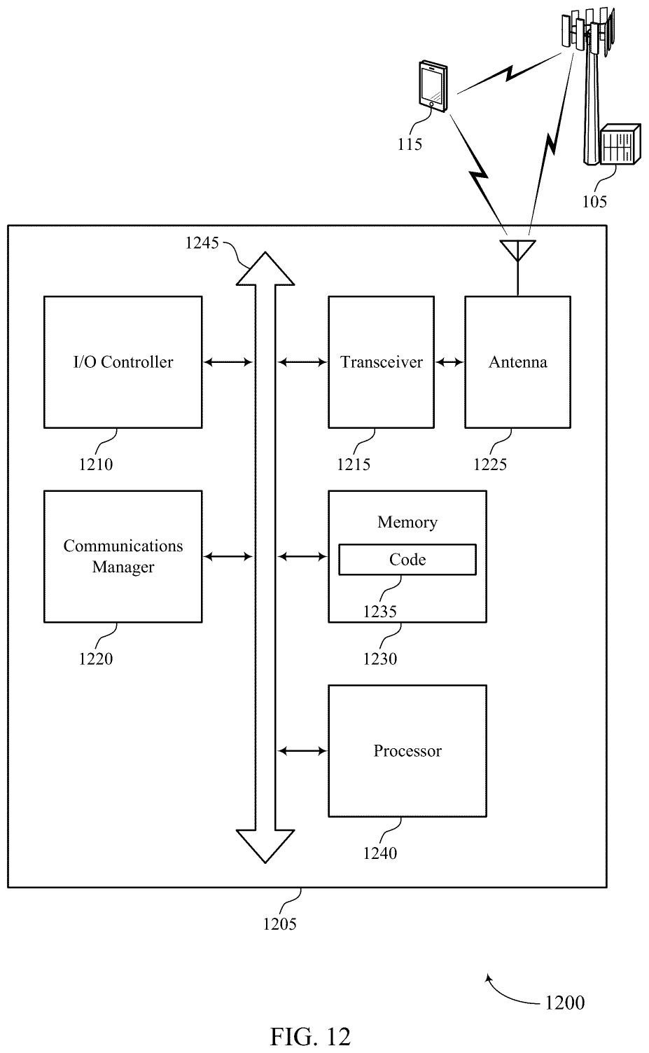

FIG. 12 shows a diagram of a system 1200 including a device 1205 that supports control channel reception in full duplex time intervals in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting control channel reception in full duplex time intervals). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving control signaling indicating a CORESET during a full duplex slot, the CORESET including a set of multiple control channel candidates associated with a downlink control channel, where the CORESET at least partially overlaps in frequency with an uplink subband of a SBFD slot. The communications manager 1220 may be configured as or otherwise support a means for selecting, for monitoring by the UE during the SBFD slot, a quantity of control channel candidates from the set of multiple control channel candidates of the CORESET that at least partially overlaps in frequency with the uplink subband.

By including or configuring the communications manager 1220 in accordance with examples as described herein, the device 1205 may support techniques for CORESET monitoring in SBFD subbands, which may result in increased reliability of control signaling, reduced retransmissions, efficient use of available system resources, decreased system latency, increased flexibility, and improved user experience.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of control channel reception in full duplex time intervals as described herein, or the processor 1240 and the memory 1230 may be otherwise configured to perform or support such operations.

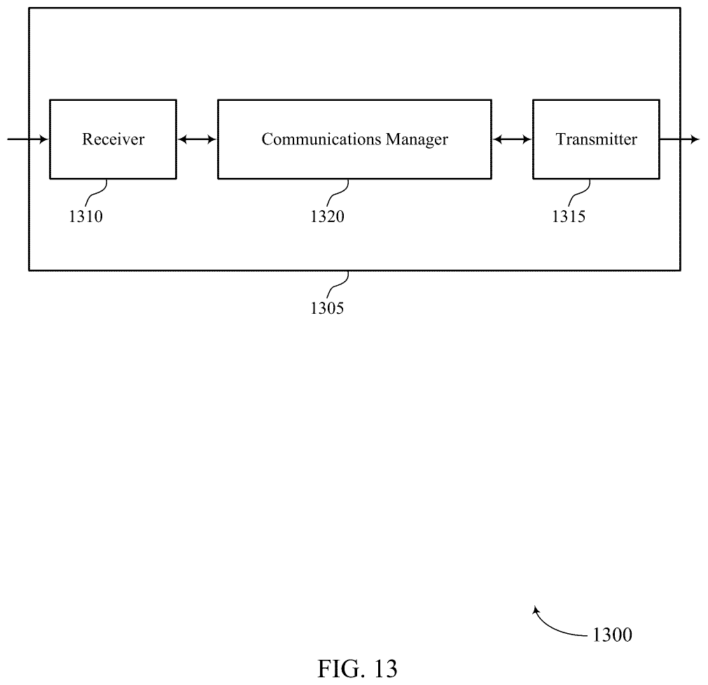

FIG. 13 shows a block diagram 1300 of a device 1305 that supports control channel reception in full duplex time intervals in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of control channel reception in full duplex time intervals as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. For example, the communications manager 1320 may be configured as or otherwise support a means for transmitting control signaling indicating a CORESET during a full duplex slot, the CORESET including a set of multiple control channel candidates associated with a downlink control channel, where the CORESET at least partially overlaps in frequency with an uplink subband of a SBFD slot. The communications manager 1320 may be configured as or otherwise support a means for selecting, for monitoring by a UE during the SBFD slot, a quantity of control channel candidates from the set of multiple control channel candidates of the CORESET that at least partially overlaps in frequency with the uplink subband.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for CORESET monitoring in SBFD subbands, which may result in increased reliability of control signaling, reduced retransmissions, efficient use of available system resources, decreased system latency, increased flexibility, and improved user experience.

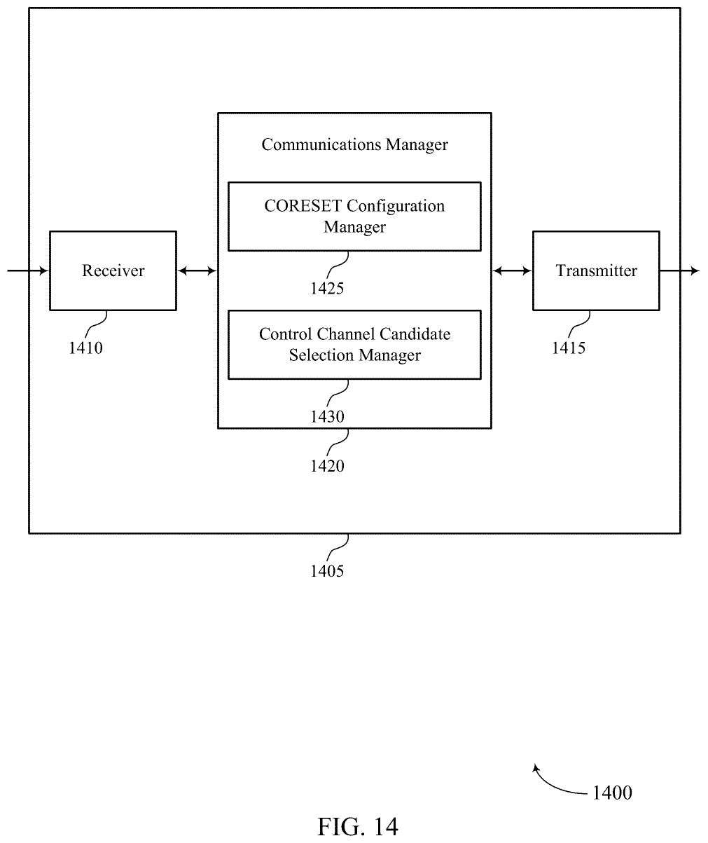

FIG. 14 shows a block diagram 1400 of a device 1405 that supports control channel reception in full duplex time intervals in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of control channel reception in full duplex time intervals as described herein. For example, the communications manager 1420 may include a CORESET configuration manager 1425 a control channel candidate selection manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. The CORESET configuration manager 1425 may be configured as or otherwise support a means for transmitting control signaling indicating a CORESET during a full duplex slot, the CORESET including a set of multiple control channel candidates associated with a downlink control channel, where the CORESET at least partially overlaps in frequency with an uplink subband of a SBFD slot. The control channel candidate selection manager 1430 may be configured as or otherwise support a means for selecting, for monitoring by a UE during the SBFD slot, a quantity of control channel candidates from the set of multiple control channel candidates of the CORESET that at least partially overlaps in frequency with the uplink subband.

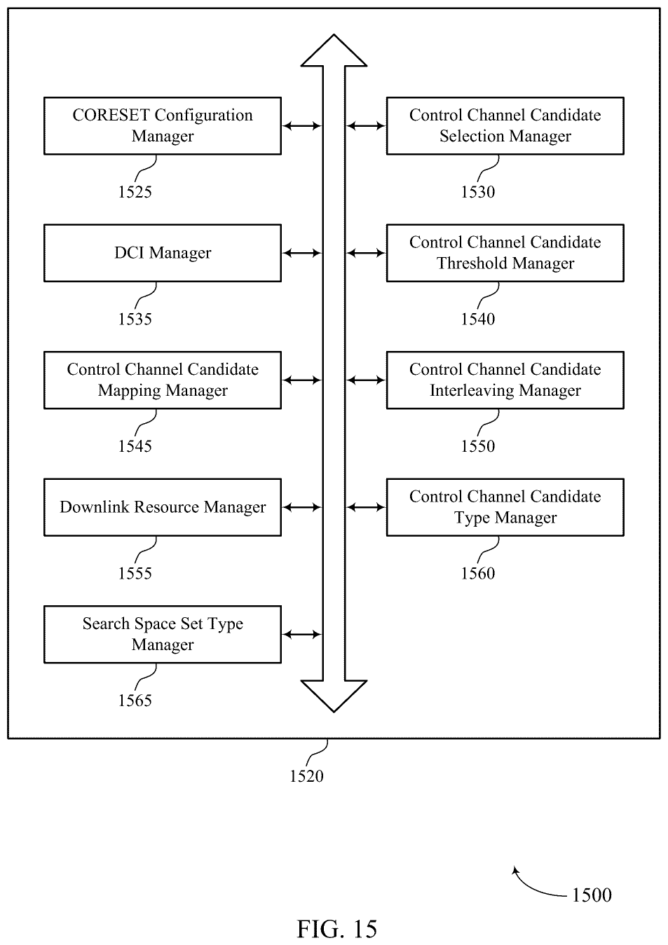

FIG. 15 shows a block diagram 1500 of a communications manager 1520 that supports control channel reception in full duplex time intervals in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of control channel reception in full duplex time intervals as described herein. For example, the communications manager 1520 may include a CORESET configuration manager 1525, a control channel candidate selection manager 1530, a DCI manager 1535, a control channel candidate threshold manager 1540, a control channel candidate mapping manager 1545, a control channel candidate interleaving manager 1550, a downlink resource manager 1555, a control channel candidate type manager 1560, a search space set type manager 1565, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a network entity in accordance with examples as disclosed herein. The CORESET configuration manager 1525 may be configured as or otherwise support a means for transmitting control signaling indicating a CORESET during a full duplex slot, the CORESET including a set of multiple control channel candidates associated with a downlink control channel, where the CORESET at least partially overlaps in frequency with an uplink subband of a SBFD slot. The control channel candidate selection manager 1530 may be configured as or otherwise support a means for selecting, for monitoring by a UE during the SBFD slot, a quantity of control channel candidates from the set of multiple control channel candidates of the CORESET that at least partially overlaps in frequency with the uplink subband.

In some examples, the DCI manager 1535 may be configured as or otherwise support a means for transmitting one or more downlink control information messages via one or more search spaces of the selected quantity of control channel candidates, where the selected quantity of control channel candidates are located in a downlink subband of the SBFD slot, where the selecting includes excluding a second quantity of control channel candidates from the set of multiple control channel candidates that are located in the uplink subband.

In some examples, the control channel candidate threshold manager 1540 may be configured as or otherwise support a means for indicating, via the control signaling, a quantity of control channel candidates based on a threshold quantity of control channel candidates associated with a quantity of frequency resources corresponding to the downlink subband, where the selecting is based on the quantity of control channel candidates satisfying the threshold quantity of control channel candidates.

In some examples, the control channel candidate mapping manager 1545 may be configured as or otherwise support a means for indicating, via the control signaling, a mapping of the set of multiple control channel candidates to a set of multiple consecutive CCEs, where a first subset of the set of multiple consecutive CCEs corresponding to the selected quantity of control channel candidates is located in the downlink subband and a second subset of the set of multiple consecutive CCEs are located in the uplink subband, where transmitting the one or more downlink control information messages is based on the mapping.

In some examples, the control channel candidate mapping manager 1545 may be configured as or otherwise support a means for indicating, via the control signaling, a mapping of the set of multiple control channel candidates to a set of multiple interleaved CCEs, where a first subset of the set of multiple interleaved CCEs corresponding to the selected quantity of control channel candidates is located in the downlink subband and a second subset of the set of multiple interleaved CCEs are located in the uplink subband, where transmitting the one or more downlink control information messages is based on the mapping.

In some examples, the control channel candidate interleaving manager 1550 may be configured as or otherwise support a means for transmitting, via the control signaling, an indication of a first interleaving pattern associated with a first set of frequency resources associated with the CORESET and a second interleaving pattern associated with a subset of the first set of frequency resources that is associated with a portion of the CORESET that overlaps with the downlink subband, where the selected quantity of control channel candidates are mapped to a set of multiple interleaved CCEs in the downlink subband based on the second interleaving pattern.

In some examples, the DCI manager 1535 may be configured as or otherwise support a means for transmitting one or more downlink control information messages via one or more search spaces of the selected quantity of control channel candidates, where a first portion of the selected quantity of control channel candidates is located in the downlink subband and a second portion of the selected quantity of control channel candidates is located in the uplink subband.

In some examples, the downlink resource manager 1555 may be configured as or otherwise support a means for determining that frequency resources of the uplink subband are allocated as downlink resources during one or more time intervals associated with the second portion of the selected quantity of control channel candidates, where transmitting the one or more downlink control information messages is based on the determining.

In some examples, the control channel candidate type manager 1560 may be configured as or otherwise support a means for transmitting, via the control signaling, an indication of a type of the CORESET, where transmitting the one or more downlink control information messages is based on the type of the CORESET.

In some examples, the search space set type manager 1565 may be configured as or otherwise support a means for transmitting, via the control signaling, an indication of the one or more search spaces that are associated with one or more downlink control information messages, where transmitting the one or more downlink control information messages is based on the indication of the one or more search spaces.

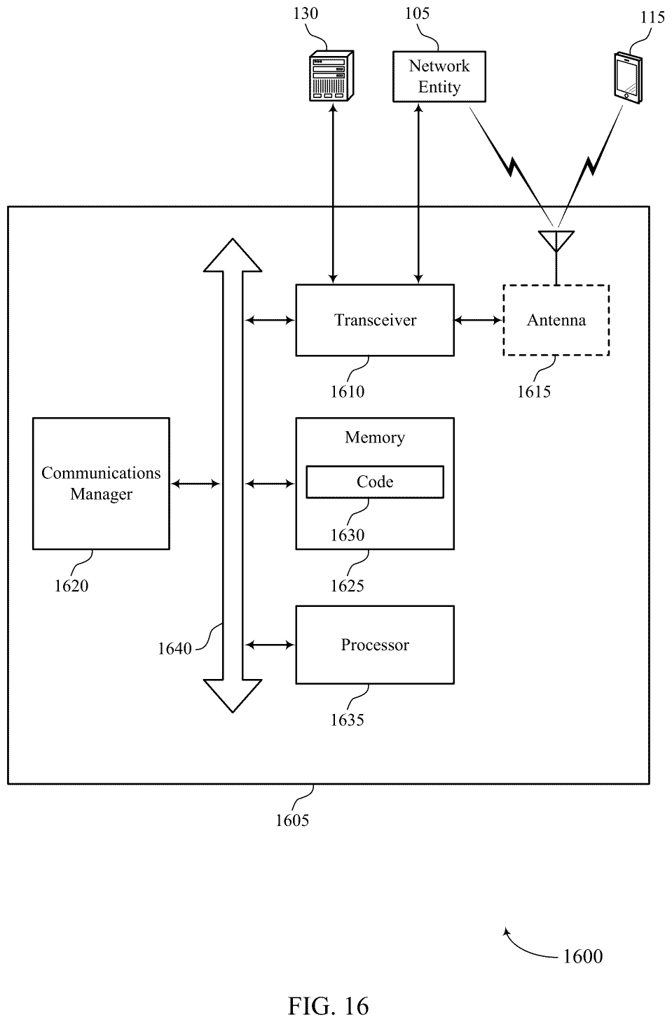

FIG. 16 shows a diagram of a system 1600 including a device 1605 that supports control channel reception in full duplex time intervals in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting control channel reception in full duplex time intervals). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a network entity in accordance with examples as disclosed herein. For example, the communications manager 1620 may be configured as or otherwise support a means for transmitting control signaling indicating a CORESET during a full duplex slot, the CORESET including a set of multiple control channel candidates associated with a downlink control channel, where the CORESET at least partially overlaps in frequency with an uplink subband of a SBFD slot. The communications manager 1620 may be configured as or otherwise support a means for selecting, for monitoring by a UE during the SBFD slot, a quantity of control channel candidates from the set of multiple control channel candidates of the CORESET that at least partially overlaps in frequency with the uplink subband.

By including or configuring the communications manager 1620 in accordance with examples as described herein, the device 1605 may support techniques for CORESET monitoring in SBFD subbands, which may result in increased reliability of control signaling, reduced retransmissions, efficient use of available system resources, decreased system latency, increased flexibility, and improved user experience.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of control channel reception in full duplex time intervals as described herein, or the processor 1635 and the memory 1625 may be otherwise configured to perform or support such operations.

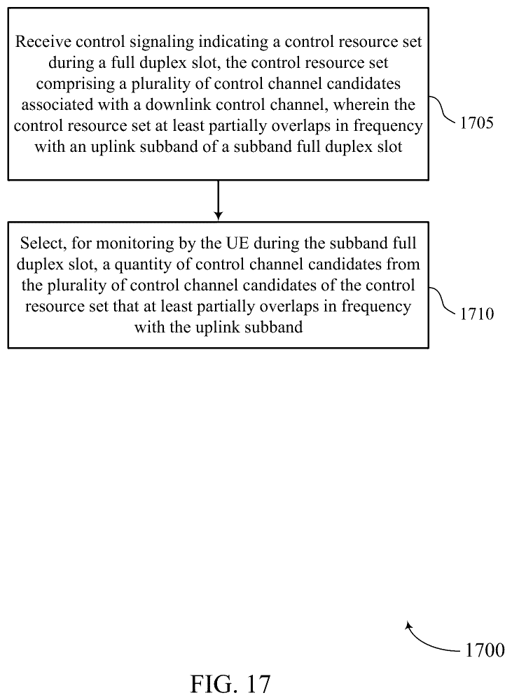

FIG. 17 shows a flowchart illustrating a method 1700 that supports control channel reception in full duplex time intervals in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving control signaling indicating a CORESET during a full duplex slot, the CORESET including a set of multiple control channel candidates associated with a downlink control channel, where the CORESET at least partially overlaps in frequency with an uplink subband of a SBFD slot. The operations of 1705 may be performed in accordance with examples as disclosed herein. In some examples, aspects of the operations of 1705 may be performed by a CORESET configuration manager 1125 as described with reference to FIG. 11.

At 1710, the method may include selecting, for monitoring by the UE during the SBFD slot, a quantity of control channel candidates from the set of multiple control channel candidates of the CORESET that at least partially overlaps in frequency with the uplink subband. The operations of 1710 may be performed in accordance with examples as disclosed herein. In some examples, aspects of the operations of 1710 may be performed by a control channel candidate selection manager 1130 as described with reference to FIG. 11.

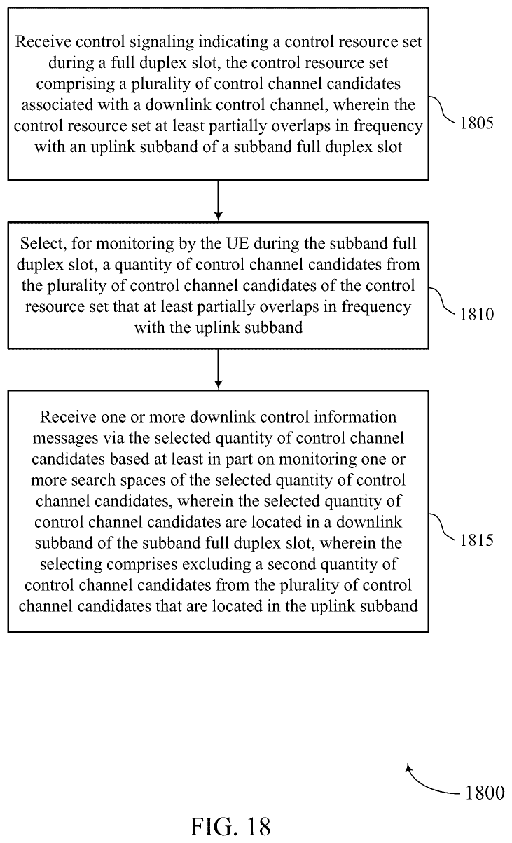

FIG. 18 shows a flowchart illustrating a method 1800 that supports control channel reception in full duplex time intervals in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving control signaling indicating a CORESET during a full duplex slot, the CORESET including a set of multiple control channel candidates associated with a downlink control channel, where the CORESET at least partially overlaps in frequency with an uplink subband of a SBFD slot. The operations of 1805 may be performed in accordance with examples as disclosed herein. In some examples, aspects of the operations of 1805 may be performed by a CORESET configuration manager 1125 as described with reference to FIG. 11.

At 1810, the method may include selecting, for monitoring by the UE during the SBFD slot, a quantity of control channel candidates from the set of multiple control channel candidates of the CORESET that at least partially overlaps in frequency with the uplink subband. The operations of 1810 may be performed in accordance with examples as disclosed herein. In some examples, aspects of the operations of 1810 may be performed by a control channel candidate selection manager 1130 as described with reference to FIG. 11.

At 1815, the method may include receiving one or more downlink control information messages via the selected quantity of control channel candidates based on monitoring one or more search spaces of the selected quantity of control channel candidates, where the selected quantity of control channel candidates are located in a downlink subband of the SBFD slot, where the selecting includes excluding a second quantity of control channel candidates from the set of multiple control channel candidates that are located in the uplink subband. The operations of 1815 may be performed in accordance with examples as disclosed herein. In some examples, aspects of the operations of 1815 may be performed by a DCI manager 1135 as described with reference to FIG. 11.

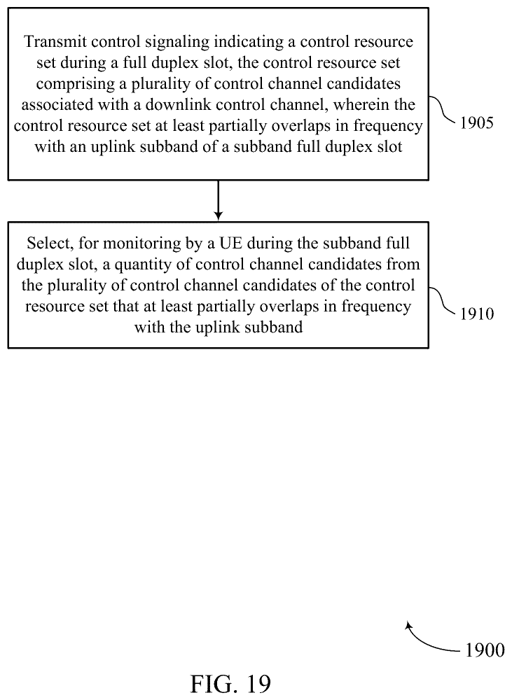

FIG. 19 shows a flowchart illustrating a method 1900 that supports control channel reception in full duplex time intervals in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting control signaling indicating a CORESET during a full duplex slot, the CORESET including a set of multiple control channel candidates associated with a downlink control channel, where the CORESET at least partially overlaps in frequency with an uplink subband of a SBFD slot. The operations of 1905 may be performed in accordance with examples as disclosed herein. In some examples, aspects of the operations of 1905 may be performed by a CORESET configuration manager 1525 as described with reference to FIG. 15.

At 1910, the method may include selecting, for monitoring by a UE during the SBFD slot, a quantity of control channel candidates from the set of multiple control channel candidates of the CORESET that at least partially overlaps in frequency with the uplink subband. The operations of 1910 may be performed in accordance with examples as disclosed herein. In some examples, aspects of the operations of 1910 may be performed by a control channel candidate selection manager 1530 as described with reference to FIG. 15.

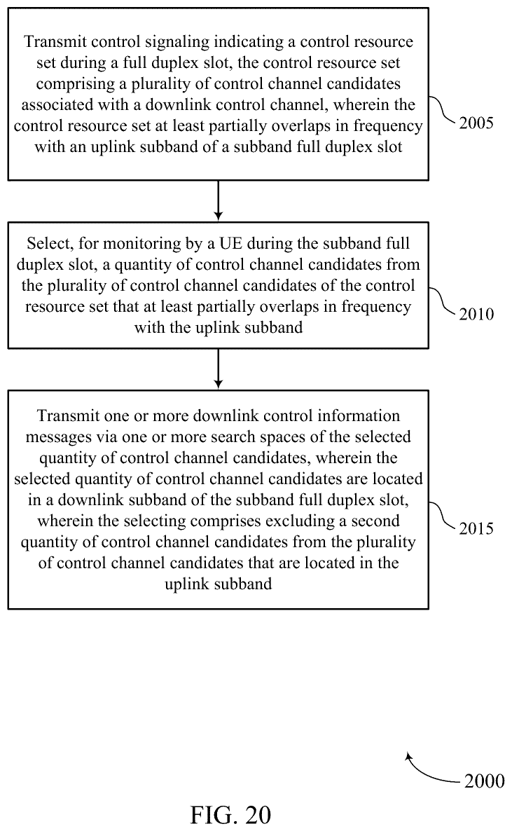

FIG. 20 shows a flowchart illustrating a method 2000 that supports control channel reception in full duplex time intervals in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include transmitting control signaling indicating a CORESET during a full duplex slot, the CORESET including a set of multiple control channel candidates associated with a downlink control channel, where the CORESET at least partially overlaps in frequency with an uplink subband of a SBFD slot. The operations of 2005 may be performed in accordance with examples as disclosed herein. In some examples, aspects of the operations of 2005 may be performed by a CORESET configuration manager 1525 as described with reference to FIG. 15.

At 2010, the method may include selecting, for monitoring by a UE during the SBFD slot, a quantity of control channel candidates from the set of multiple control channel candidates of the CORESET that at least partially overlaps in frequency with the uplink subband. The operations of 2010 may be performed in accordance with examples as disclosed herein. In some examples, aspects of the operations of 2010 may be performed by a control channel candidate selection manager 1530 as described with reference to FIG. 15.

At 2015, the method may include transmitting one or more downlink control information messages via one or more search spaces of the selected quantity of control channel candidates, where the selected quantity of control channel candidates are located in a downlink subband of the SBFD slot, where the selecting includes excluding a second quantity of control channel candidates from the set of multiple control channel candidates that are located in the uplink subband. The operations of 2015 may be performed in accordance with examples as disclosed herein. In some examples, aspects of the operations of 2015 may be performed by a DCI manager 1535 as described with reference to FIG. 15.

The following provides an overview of aspects of the present disclosure:

Aspect 1: A method for wireless communications at a UE, comprising: receiving control signaling indicating a CORESET during a full duplex slot, the CORESET comprising a plurality of control channel candidates associated with a downlink control channel, wherein the CORESET at least partially overlaps in frequency with an uplink subband of a SBFD slot; and selecting, for monitoring by the UE during the SBFD slot, a quantity of control channel candidates from the plurality of control channel candidates of the CORESET that at least partially overlaps in frequency with the uplink subband.

Aspect 2: The method of aspect 1, further comprising: receiving one or more downlink control information messages via the selected quantity of control channel candidates based at least in part on monitoring one or more search spaces of the selected quantity of control channel candidates, wherein the selected quantity of control channel candidates are located in a downlink subband of the SBFD slot, wherein the selecting comprises excluding a second quantity of control channel candidates from the plurality of control channel candidates that are located in the uplink subband.

Aspect 3: The method of aspect 2, wherein the selected quantity of control channel candidates satisfies a threshold quantity of control channel candidates associated with a quantity of frequency resources corresponding to the downlink subband, and the selecting is based at least in part on the quantity of control channel candidates satisfying the threshold quantity of control channel candidates.

Aspect 4: The method of any of aspects 2 through 3, further comprising: mapping the plurality of control channel candidates to a plurality of consecutive CCEs based at least in part on the control signaling, wherein a first subset of the plurality of consecutive CCEs corresponding to the selected quantity of control channel candidates is located in the downlink subband and a second subset of the plurality of consecutive CCEs is located in the uplink subband, wherein the receiving is based least in part on the mapping.

Aspect 5: The method of any of aspects 2 through 4, further comprising: mapping the plurality of control channel candidates to a plurality of interleaved CCEs based at least in part on the control signaling, wherein a first subset of the plurality of interleaved CCEs corresponding to the selected quantity of control channel candidates is located in the downlink subband and a second subset of the plurality of interleaved CCEs is located in the uplink subband, wherein the receiving is based at least in part on the mapping, and wherein the first subset of the plurality of interleaved CCEs corresponds to the selected quantity of control channel candidates.

Aspect 6: The method of any of aspects 2 through 5, further comprising: receiving, via the control signaling, an indication of a first interleaving pattern associated with a first set of frequency resources associated with the CORESET and a second interleaving pattern associated with a subset of the first set of frequency resources that is associated with a portion of the CORESET that overlaps with downlink subband; and mapping the selected quantity of control channel candidates to a plurality of interleaved CCEs in the SBFD slot based at least in part on the second interleaving pattern, wherein the plurality of interleaved CCEs are located in the downlink subband, and wherein receiving the one or more downlink control information messages is based at least in part on the mapping.

Aspect 7: The method of any of aspects 1 through 6, further comprising: receiving one or more downlink control information messages via the selected quantity of control channel candidates based at least in part on monitoring one or more search spaces of the selected quantity of control channel candidates, wherein a first portion of the selected quantity of control channel candidates is located in a downlink subband of the SBFD slot and a second portion of the selected quantity of control channel candidates is located in the uplink subband.

Aspect 8: The method of aspect 7, further comprising: determining that frequency resources of the uplink subband are allocated as downlink resources during one or more time intervals associated with the second portion of the selected quantity of control channel candidates, wherein receiving the one or more downlink control information messages is based at least in part on the determining.

Aspect 9: The method of any of aspects 7 through 8, further comprising: receiving, via the control signaling, an indication of a type of the CORESET, wherein receiving the one or more downlink control information messages is based at least in part on the type of the CORESET.

Aspect 10: The method of any of aspects 7 through 9, further comprising: receiving, via the control signaling, an indication of the one or more search spaces that are associated with the one or more downlink control information messages, wherein receiving the one or more downlink control information messages is based at least in part on the indication of the one or more search spaces.

Aspect 11: A method for wireless communications at a network entity, comprising: transmitting control signaling indicating a CORESET during a full duplex slot, the CORESET comprising a plurality of control channel candidates associated with a downlink control channel, wherein the CORESET at least partially overlaps in frequency with an uplink subband of a SBFD slot; and selecting, for monitoring by a UE during the SBFD slot, a quantity of control channel candidates from the plurality of control channel candidates of the CORESET that at least partially overlaps in frequency with the uplink subband.

Aspect 12: The method of aspect 11, further comprising: transmitting one or more downlink control information messages via one or more search spaces of the selected quantity of control channel candidates, wherein the selected quantity of control channel candidates are located in a downlink subband of the SBFD slot, wherein the selecting comprises excluding a second quantity of control channel candidates from the plurality of control channel candidates that are located in the uplink subband.

Aspect 13: The method of aspect 12, further comprising: indicating, via the control signaling, a quantity of control channel candidates based at least in part on a threshold quantity of control channel candidates associated with a quantity of frequency resources corresponding to the downlink subband, wherein the selecting is based at least in part on the quantity of control channel candidates satisfying the threshold quantity of control channel candidates.

Aspect 14: The method of any of aspects 12 through 13, further comprising: indicating, via the control signaling, a mapping of the plurality of control channel candidates to a plurality of consecutive CCEs, wherein a first subset of the plurality of consecutive CCEs corresponding to the selected quantity of control channel candidates is located in the downlink subband and a second subset of the plurality of consecutive CCEs are located in the uplink subband, wherein transmitting the one or more downlink control information messages is based at least in part on the mapping.

Aspect 15: The method of any of aspects 12 through 14, further comprising: indicating, via the control signaling, a mapping of the plurality of control channel candidates to a plurality of interleaved CCEs, wherein a first subset of the plurality of interleaved CCEs corresponding to the selected quantity of control channel candidates is located in the downlink subband and a second subset of the plurality of interleaved CCEs are located in the uplink subband, wherein transmitting the one or more downlink control information messages is based at least in part on the mapping.

Aspect 16: The method of any of aspects 12 through 15, further comprising: transmitting, via the control signaling, an indication of a first interleaving pattern associated with a first set of frequency resources associated with the CORESET and a second interleaving pattern associated with a subset of the first set of frequency resources that is associated with a portion of the CORESET that overlaps with the downlink subband, wherein the selected quantity of control channel candidates are mapped to a plurality of interleaved CCEs in the downlink subband based at least in part on the second interleaving pattern.

Aspect 17: The method of any of aspects 11 through 16, further comprising: transmitting one or more downlink control information messages via one or more search spaces of the selected quantity of control channel candidates, wherein a first portion of the selected quantity of control channel candidates is located in the downlink subband and a second portion of the selected quantity of control channel candidates is located in the uplink subband.

Aspect 18: The method of aspect 17, further comprising: determining that frequency resources of the uplink subband are allocated as downlink resources during one or more time intervals associated with the second portion of the selected quantity of control channel candidates, wherein transmitting the one or more downlink control information messages is based at least in part on the determining.

Aspect 19: The method of any of aspects 17 through 18, further comprising: transmitting, via the control signaling, an indication of a type of the CORESET, wherein transmitting the one or more downlink control information messages is based at least in part on the type of the CORESET.

Aspect 20: The method of any of aspects 17 through 19, further comprising: transmitting, via the control signaling, an indication of the one or more search spaces that are associated with one or more downlink control information messages, wherein transmitting the one or more downlink control information messages is based at least in part on the indication of the one or more search spaces.

Aspect 21: An apparatus for wireless communications at a UE, comprising a processor; memory coupled with the processor; and instructions stored in the memory and executable by the processor to cause the apparatus to perform a method of any of aspects 1 through 10.

Aspect 22: An apparatus for wireless communications at a UE, comprising at least one means for performing a method of any of aspects 1 through 10.

Aspect 23: A non-transitory computer-readable medium storing code for wireless communications at a UE, the code comprising instructions executable by a processor to perform a method of any of aspects 1 through 10.

Aspect 24: An apparatus for wireless communications at a network entity, comprising a processor; memory coupled with the processor; and instructions stored in the memory and executable by the processor to cause the apparatus to perform a method of any of aspects 11 through 20.

Aspect 25: An apparatus for wireless communications at a network entity, comprising at least one means for performing a method of any of aspects 11 through 20.

Aspect 26: A non-transitory computer-readable medium storing code for wireless communications at a network entity, the code comprising instructions executable by a processor to perform a method of any of aspects 11 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
at least one memory coupled with the at least one processor, with instructions stored in the at least one memory, the instructions being executable by the at least one processor, individually or in any combination, to cause the apparatus to:
receive control signaling indicating a control resource set during a full duplex slot, the control resource set comprising a plurality of control channel candidates associated with a downlink control channel, wherein the control resource set at least partially overlaps in frequency with an uplink subband of a full duplex slot; and
select, for monitoring by the UE during the full duplex slot, a quantity of control channel candidates from the plurality of control channel candidates of the control resource set that at least partially overlaps in frequency with the uplink subband.

2. The apparatus of claim 1, wherein the instructions are further executable by the at least one processor to:
receive one or more downlink control information messages via the selected quantity of control channel candidates based at least in part on monitoring one or more search spaces of the selected quantity of control channel candidates, wherein the selected quantity of control channel candidates are located in a downlink subband of the full duplex slot, wherein the selecting comprises excluding a second quantity of control channel candidates from the plurality of control channel candidates that are located in the uplink subband.

3. The apparatus of claim 2, wherein the selected quantity of control channel candidates satisfies a threshold quantity of control channel candidates associated with a quantity of frequency resources corresponding to the downlink subband, and the selecting is based at least in part on the quantity of control channel candidates satisfying the threshold quantity of control channel candidates.

4. The apparatus of claim 2, wherein the instructions are further executable by the at least one processor to:
map the plurality of control channel candidates to a plurality of consecutive control channel elements based at least in part on the control signaling, wherein a first subset of the plurality of consecutive control channel elements corresponding to the selected quantity of control channel candidates is located in the downlink subband and a second subset of the plurality of consecutive control channel elements is located in the uplink subband, wherein the receiving is based least in part on the mapping.

5. The apparatus of claim 2, wherein the instructions are further executable by the at least one processor to:
map the plurality of control channel candidates to a plurality of interleaved control channel elements based at least in part on the control signaling, wherein a first subset of the plurality of interleaved control channel elements corresponding to the selected quantity of control channel candidates is located in the downlink subband and a second subset of the plurality of interleaved control channel elements is located in the uplink subband, wherein the receiving is based at least in part on the mapping, and wherein the first subset of the plurality of interleaved control channel elements corresponds to the selected quantity of control channel candidates.

6. The apparatus of claim 2, wherein the instructions are further executable by the at least one processor to:
receive, via the control signaling, an indication of a first interleaving pattern associated with a first set of frequency resources associated with the control resource set and a second interleaving pattern associated with a subset of the first set of frequency resources that is associated with a portion of the control resource set that overlaps with downlink subband; and
map the selected quantity of control channel candidates to a plurality of interleaved control channel elements in the full duplex slot based at least in part on the second interleaving pattern, wherein the plurality of interleaved control channel elements are located in the downlink subband, and wherein receiving the one or more downlink control information messages is based at least in part on the mapping.

7. The apparatus of claim 1, wherein the instructions are further executable by the at least one processor to:
receive one or more downlink control information messages via the selected quantity of control channel candidates based at least in part on monitoring one or more search spaces of the selected quantity of control channel candidates, wherein a first portion of the selected quantity of control channel candidates is located in a downlink subband of the full duplex slot and a second portion of the selected quantity of control channel candidates is located in the uplink subband.

8. The apparatus of claim 7, wherein the instructions are further executable by the at least one processor to:
determine that frequency resources of the uplink subband are allocated as downlink resources during one or more time intervals associated with the second portion of the selected quantity of control channel candidates, wherein receiving the one or more downlink control information messages is based at least in part on the determining.

9. The apparatus of claim 7, wherein the instructions are further executable by the at least one processor to:
receive, via the control signaling, an indication of a type of the control resource set, wherein receiving the one or more downlink control information messages is based at least in part on the type of the control resource set.

10. The apparatus of claim 7, wherein the instructions are further executable by the at least one processor to:
receive, via the control signaling, an indication of the one or more search spaces that are associated with the one or more downlink control information messages, wherein receiving the one or more downlink control information messages is based at least in part on the indication of the one or more search spaces.

11. The apparatus of claim 7, wherein the full duplex slot comprises a subband full duplex slot.

12. The apparatus of claim 7, wherein the control resource set at least partially overlaps in frequency with a guard band of the full duplex slot.

13. An apparatus for wireless communications at a network entity, comprising:
at least one processor; and
at least one memory coupled with the at least one processor, with instructions stored in the at least one memory, the instructions being executable by the at least one processor, individually or in any combination, to cause the apparatus to:
transmit control signaling indicating a control resource set during a full duplex slot, the control resource set comprising a plurality of control channel candidates associated with a downlink control channel, wherein the control resource set at least partially overlaps in frequency with an uplink subband of a full duplex slot; and
select, for monitoring by a user equipment (UE) during the full duplex slot, a quantity of control channel candidates from the plurality of control channel candidates of the control resource set that at least partially overlaps in frequency with the uplink subband.

14. The apparatus of claim 13, wherein the instructions are further executable by the at least one processor to:
transmit one or more downlink control information messages via one or more search spaces of the selected quantity of control channel candidates, wherein the selected quantity of control channel candidates are located in a downlink subband of the full duplex slot, wherein the selecting comprises excluding a second quantity of control channel candidates from the plurality of control channel candidates that are located in the uplink subband.

15. The apparatus of claim 14, wherein the instructions are further executable by the at least one processor to:
indicate, via the control signaling, a quantity of control channel candidates based at least in part on a threshold quantity of control channel candidates associated with a quantity of frequency resources corresponding to the downlink subband, wherein the selecting is based at least in part on the quantity of control channel candidates satisfying the threshold quantity of control channel candidates.

16. The apparatus of claim 14, wherein the instructions are further executable by the at least one processor to:
indicate, via the control signaling, a mapping of the plurality of control channel candidates to a plurality of consecutive control channel elements, wherein a first subset of the plurality of consecutive control channel elements corresponding to the selected quantity of control channel candidates is located in the downlink subband and a second subset of the plurality of consecutive control channel elements are located in the uplink subband, wherein transmitting the one or more downlink control information messages is based at least in part on the mapping.

17. The apparatus of claim 14, wherein the instructions are further executable by the at least one processor to:
indicate, via the control signaling, a mapping of the plurality of control channel candidates to a plurality of interleaved control channel elements, wherein a first subset of the plurality of interleaved control channel elements corresponding to the selected quantity of control channel candidates is located in the downlink subband and a second subset of the plurality of interleaved control channel elements are located in the uplink subband, wherein transmitting the one or more downlink control information messages is based at least in part on the mapping.

18. The apparatus of claim 14, wherein the instructions are further executable by the at least one processor to:
transmit, via the control signaling, an indication of a first interleaving pattern associated with a first set of frequency resources associated with the control resource set and a second interleaving pattern associated with a subset of the first set of frequency resources that is associated with a portion of the control resource set that overlaps with the downlink subband, wherein the selected quantity of control channel candidates are mapped to a plurality of interleaved control channel elements in the downlink subband based at least in part on the second interleaving pattern.

19. The apparatus of claim 13, wherein the instructions are further executable by the at least one processor to:
transmit one or more downlink control information messages via one or more search spaces of the selected quantity of control channel candidates, wherein a first portion of the selected quantity of control channel candidates is located in the downlink subband and a second portion of the selected quantity of control channel candidates is located in the uplink subband.

20. The apparatus of claim 19, wherein the instructions are further executable by the at least one processor to:
determine that frequency resources of the uplink subband are allocated as downlink resources during one or more time intervals associated with the second portion of the selected quantity of control channel candidates, wherein transmitting the one or more downlink control information messages is based at least in part on the determining.

21. The apparatus of claim 19, wherein the instructions are further executable by the at least one processor to:
transmit, via the control signaling, an indication of a type of the control resource set, wherein transmitting the one or more downlink control information messages is based at least in part on the type of the control resource set.

22. The apparatus of claim 19, wherein the instructions are further executable by the at least one processor to:
transmit, via the control signaling, an indication of the one or more search spaces that are associated with one or more downlink control information messages, wherein transmitting the one or more downlink control information messages is based at least in part on the indication of the one or more search spaces.

23. The apparatus of claim 13, wherein the full duplex slot comprises a subband full duplex slot.

24. The apparatus of claim 13, wherein the control resource set at least partially overlaps in frequency with a guard band of the full duplex slot.

25. A method for wireless communications at a user equipment (UE), comprising:
receiving control signaling indicating a control resource set during a full duplex slot, the control resource set comprising a plurality of control channel candidates associated with a downlink control channel, wherein the control resource set at least partially overlaps in frequency with an uplink subband of a full duplex slot; and
selecting, for monitoring by the UE during the full duplex slot, a quantity of control channel candidates from the plurality of control channel candidates of the control resource set that at least partially overlaps in frequency with the uplink subband.

26. The method of claim 25, further comprising:
receiving one or more downlink control information messages via the selected quantity of control channel candidates based at least in part on monitoring one or more search spaces of the selected quantity of control channel candidates, wherein the selected quantity of control channel candidates are located in a downlink subband of the full duplex slot, wherein the selecting comprises excluding a second quantity of control channel candidates from the plurality of control channel candidates that are located in the uplink subband.

27. The method of claim 25, further comprising:
receiving one or more downlink control information messages via the selected quantity of control channel candidates based at least in part on monitoring one or more search spaces of the selected quantity of control channel candidates, wherein a first portion of the selected quantity of control channel candidates is located in a downlink subband of the full duplex slot and a second portion of the selected quantity of control channel candidates is located in the uplink subband.

28. A method for wireless communications at a network entity, comprising:
transmitting control signaling indicating a control resource set during a full duplex slot, the control resource set comprising a plurality of control channel candidates associated with a downlink control channel, wherein the control resource set at least partially overlaps in frequency with an uplink subband of a full duplex slot; and
selecting, for monitoring by a user equipment (UE) during the full duplex slot, a quantity of control channel candidates from the plurality of control channel candidates of the control resource set that at least partially overlaps in frequency with the uplink subband.

29. The method of claim 28, further comprising:
transmitting one or more downlink control information messages via one or more search spaces of the selected quantity of control channel candidates, wherein the selected quantity of control channel candidates are located in a downlink subband of the full duplex slot, wherein the selecting comprises excluding a second quantity of control channel candidates from the plurality of control channel candidates that are located in the uplink subband.

30. The method of claim 28, further comprising:
transmitting one or more downlink control information messages via one or more search spaces of the selected quantity of control channel candidates, wherein a first portion of the selected quantity of control channel candidates is located in the downlink subband and a second portion of the selected quantity of control channel candidates is located in the uplink subband.
